(19) United States
(12) Patent Application Publication
(10) Pub. No.: US 2020/0330943 A1
(43) Pub. Date: Oct. 22, 2020

(54) APPARATUS FOR MAINTAINING A PRESSURE DIFFERENT FROM ATMOSPHERIC PRESSURE, METHODS OF FORMING AND OPERATING THE SAME

(71) Applicant: Agency for Science, Technology and Research, Singapore (SG)

(72) Inventors: Dmitry Isakov, Singapore (SG); Siew Soon Vong, Singapore (SG); Huang Ming Chong, Singapore (SG); Stefanie Feih, Singapore (SG)

(21) Appl. No.: 16/756,612

(22) PCT Filed: Oct. 23, 2018
(86) PCT No.: PCT/SG2018/050524

§ 371 Date: Apr. 16, 2020

(30) Foreign Application Priority Data
Oct. 23, 2017 (SG) 10201708678U
Sep. 7, 2018 (SG) 10201807688U

(51) Int. Cl. B01J 3/00; B29C 70/44

(52) U.S. Cl. CPC B01J 3/006; B29C 70/44

(57) ABSTRACT

Various embodiments may provide an apparatus for maintaining a pressure different from atmospheric pressure. The apparatus may include a plurality of structural members coupled together to at least partially define a space which is configured to have a pressure different from atmospheric pressure, a structural member of the plurality of structural members being a support structure having an array of holes. The apparatus may also include a film covering a surface of the support structure having an array of holes. The film maybe adapted to allow a predetermined range of wavelengths of electromagnetic waves to pass through.

### CROSS-REFERENCE TO RELATED APPLICATION

This application claims the benefit of priority of Singapore application No. 10201708678U filed on Oct. 23, 2017 and Singapore application No. 10201807688U filed on Sep. 7, 2018, the contents of them being hereby incorporated by reference in their entirety for all purposes.

### TECHNICAL FIELD

Various embodiments relate to an apparatus or an enclosure for maintaining a pressure different from atmospheric pressure or for maintaining a pressure difference with external environment. In particular, various embodiments may relate to an apparatus including a film that minimizes the weight of such enclosures and allows them to be at least partially transparent in a broad range of the electromagnetic spectrum. Various aspects of this disclosure relate to a method of forming an apparatus or an enclosure for maintaining a pressure different from atmospheric pressure or for maintaining a pressure difference with external environment. Various aspects of this disclosure relate to a method of forming an apparatus including a film. Various aspects of this disclosure relate to a method of operating an apparatus or an enclosure for maintaining a pressure different from atmospheric pressure or for maintain a pressure difference with external environment. Various aspects of this disclosure relate to a method of operating an apparatus including a film. Various aspects of this disclosure relate to embodiments that are applicable for one or more specific applications.

### BACKGROUND

A vacuum chamber is a rigid enclosure from which air and other gases are removed by a vacuum pump. As a result, a low-pressure environment within the chamber is attained, commonly referred to as a vacuum. A vacuum environment allows conducting physical experiments, performing measurements and employing industrial processes that are not possible in standard atmospheric conditions.

Vacuum chambers are commonly made of thick solid material, like metal or plastic, and are supplied with thick observation windows that can be catered to different wavelength ranges. Vacuum chambers may not be subject to any specific design guideline or any specific calculation requirement. The walls of the chamber should be strong enough to prevent significant deflection under the given pressure difference. An important potential issue to note is that surface deflection can lead to warping of the sealed edges, which may lead to leakage of the chamber. Apart from increase in wall thickness, reduction of surface deflection may be carried out by mechanical reinforcement, for example, by additional welded ribs. In analogy to pressure vessels, the most common shapes for vacuum chambers are cylindrical or spherical, which are preferred for deflection and buckling stability.

Conventional methods of fabricating these chambers may lead to chambers that are heavy and non-portable without specialized lifting equipment, and expensive in terms of materials and construction processes. In addition, these methods often face difficulties in scaling up, are unsuitable for many applications. These vessels typically have opaque walls or have windows that are only transparent to visible light.

### SUMMARY

Various embodiments may provide an apparatus for maintaining a pressure different from atmospheric pressure. The apparatus may include a plurality of structural members coupled together to at least partially define a space which is configured to have a pressure different from atmospheric pressure, a structural member of the plurality of structural members being a support structure having an array of holes. The apparatus may also include a film covering a surface of the support structure having an array of holes. The film may be configured, adapted or chosen to allow a predetermined range of wavelengths of electromagnetic waves to pass through. In various embodiments, each of one or more further members or all members of the plurality of structural members may be a support structure having an array of holes.

Various embodiments may relate to a method of forming an apparatus for maintaining a pressure different from atmospheric pressure. The method may also include coupling a plurality of structural members together to at least partially define a space which is configured to have a pressure different from atmospheric pressure, a structural member of the plurality of structural members being a support structure having an array of holes. The film may be configured, adapted or chosen to allow a predetermined range of wavelengths of electromagnetic waves to pass through.

Various embodiments may relate to a method of operating an apparatus for maintaining a pressure different from atmospheric pressure. The method may include providing the apparatus including a plurality of structural members coupled together to at least partially define a space which is configured to have a pressure different from atmospheric pressure, a structural member of the plurality of structural members being a support structure having an array of holes, and a film covering a surface of the support structure having an array of holes. The film may be configured, adapted or chosen to allow a predetermined range of wavelengths of electromagnetic waves to pass through. The method may further include generating the pressure in the space.

Various embodiments may be suitable for repair and inspection. Various embodiments may relate to an apparatus for out-of-autoclave repair of composite primary structures. Various embodiments may relate to an apparatus wherein the plurality of structural members is coupled together to at least partially define a main chamber containing the space, and also to at least partially define a secondary chamber containing a further space configured to have a further pressure different from the pressure in the main chamber. Various embodiments may relate to a method of forming and/or operating the same.

### BRIEF DESCRIPTION OF THE DRAWINGS

The invention will be better understood with reference to the detailed description when considered in conjunction with the non-limiting examples and the accompanying drawings, in which:

FIG. 1A is a schematic showing the various components of an apparatus according to various embodiments.

FIG. 1B is a schematic showing a perspective view of the apparatus which also includes a pressure difference generator according to various embodiments.

FIG. 1C is a schematic showing different embodiments of the support structure.

FIG. 1D is a schematic illustrating the percentage of area occupied by holes in the support structure according to various embodiments.

FIG. 2A is a schematic showing a chamber according to various embodiments before vacuum is applied, i.e. when the pressure within the chamber is equal to the external pressure.

FIG. 2B is a schematic showing the chamber according to various embodiments after vacuum is applied within the chamber, i.e. when the pressure within the chamber is less than the external pressure.

FIG. 3 is a schematic showing a part of an apparatus according to various embodiments.

FIG. 4A is a schematic showing an apparatus for Vacuum Assisted Thermography (VAT) of an object according to various embodiments.

FIG. 4B is a schematic showing an exploded view of a portion of the cover or vacuum dome according to various embodiments.

FIG. 5A is a thermal image of a sample with no water ingress.

FIG. 5B is a thermal image of another sample showing some water ingress.

FIG. 6 is a schematic illustrating (1) a conventional autoclave used for curing a composite patch or structure, (2) a conventional vacuum bag used for debulking a composite patch or structure, (3) a conventional apparatus used for double vacuum debulking (DVD) of a composite patch or structure, (4) an apparatus according to various embodiments used for double vacuum debulking (DVD) of a composite patch or structure, and (5) an apparatus according to various embodiments used for debulking and/or curing of a composite patch or structure.

FIG. 7A is a schematic showing a back view of an apparatus for in-situ repair of an object according to various embodiments.

FIG. 7B shows a perspective view of the apparatus according to various embodiments.

FIG. 8A is a cross-sectional schematic showing an apparatus according to various embodiments for in-situ repair of an object.

FIG. 8B is a cross-sectional schematic showing an apparatus according to various embodiments for in-situ repair of an object.

FIG. 8C is a cross-sectional schematic showing the apparatus for in-situ repair of an object with an adjustment mechanism to non-planar surfaces according to various embodiments.

FIG. 8D is a schematic showing a perspective view of the apparatus shown in according to various embodiments.

FIG. 9 is a cross-sectional schematic showing an apparatus according to various embodiments for in-situ repair of an object.

FIG. 10A is a schematic shows a cross-section of an end portion of the structural member or wall according to various embodiments.

FIG. 10B is a schematic shows a cross-section of an end portion of the wall according to various other embodiments before vacuum is applied (left), and after vacuum is applied (right).

FIG. 11 is a general illustration of an apparatus for maintaining pressure according to various embodiments.

FIG. 12 is a general illustration of a method of forming an apparatus for maintaining a pressure different from atmospheric pressure according to various embodiments.

FIG. 13 is a general illustration of a method of operating an apparatus for maintaining a pressure different from atmospheric pressure according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

Embodiments described in the context of one of the methods or apparatuses are analogously valid for the other methods or apparatuses. Similarly, embodiments described in the context of a method are analogously valid for an apparatus, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may also be used herein to mean that the deposited material may be formed “indirectly on” the implied side or surface with one or more additional layers being arranged between the implied side or surface and the deposited material. In other words, a first layer “over” a second layer may refer to the first layer directly on the second layer, or that the first layer and the second layer are separated by one or more intervening layers.

The apparatus as described herein may be operable in various orientations, and thus it should be understood that the terms “top”, “topmost”, “bottom”, “bottommost” etc., when used in the following description are used for convenience and to aid understanding of relative positions or directions, and not intended to limit the orientation of the apparatus.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Various embodiments may provide an apparatus for maintaining a pressure different from atmospheric pressure. The apparatus may include a plurality of structural members coupled together to at least partially define a space which is configured to have a pressure different from atmospheric pressure, a structural member of the plurality of structural members being a support structure having an array of holes. The apparatus may also include a film covering a surface of the support structure having an array of holes. The film may be configured to allow a predetermined range of wavelengths of electromagnetic waves to pass through.

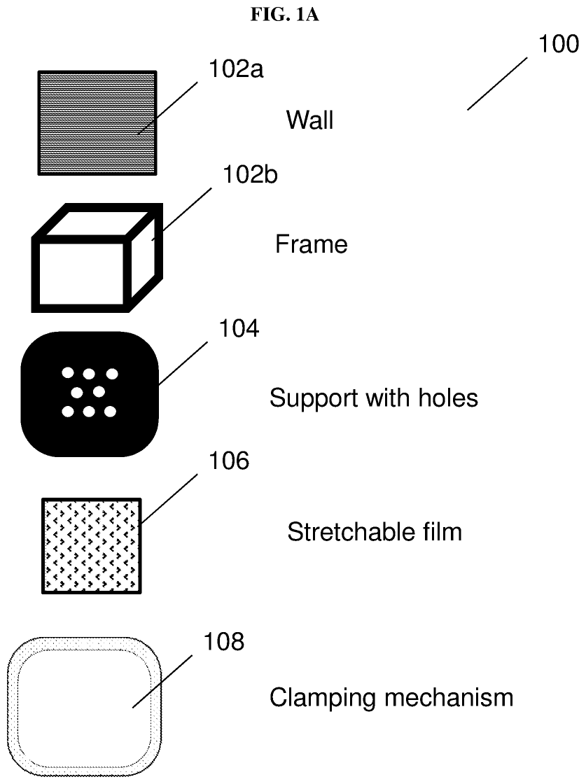

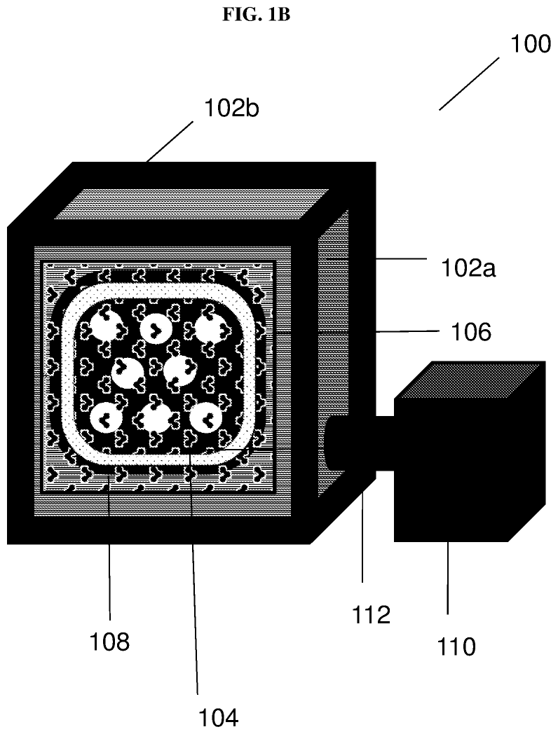

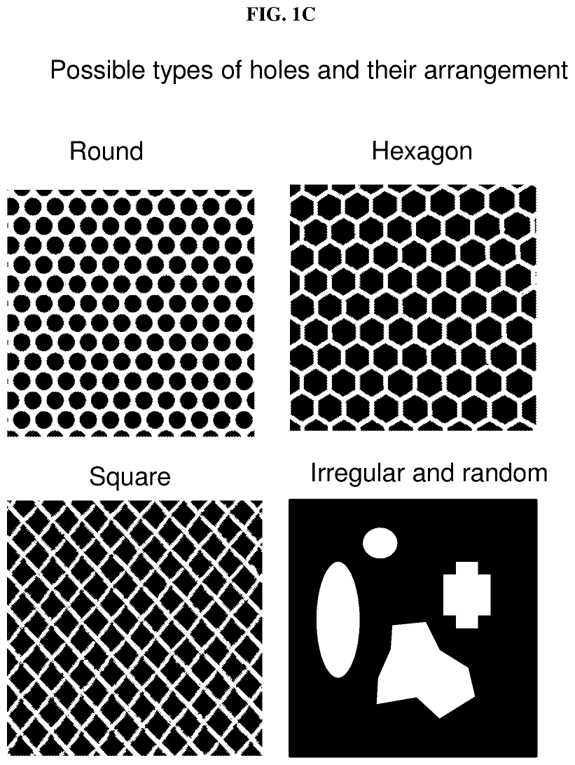

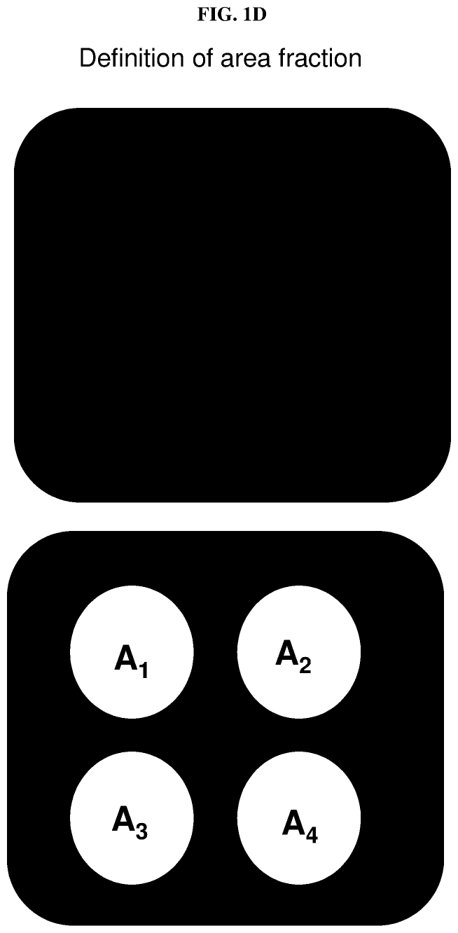

FIG. 1A is a schematic showing the various components of an apparatus 100 according to various embodiments. The apparatus 100 may include a plurality of structural members coupled together to at least partially define a space which is configured to have a pressure different from atmospheric pressure, a structural member of the plurality of structural members being a support structure having an array of holes 104. The plurality of structural members may include a plurality. of walls 102a joined together. The apparatus may also include a frame 102b holding the plurality of walls 102a.

The apparatus 100 may also include a film 106 covering a surface of the support structure having an array of holes 104. The film 106 may be configured to allow a predetermined range of wavelengths of electromagnetic waves to pass through. The apparatus may also include a clamping mechanism 108, e.g. a clamp, attached to a structural member other than the support structure having the array of holes.

FIG. 1B is a schematic showing a perspective view of the apparatus 100 which also includes a pressure difference generator according to various embodiments. As shown in FIG. 1B shown in FIG. 1A, the apparatus 100 may also include a pressure difference generator 110 coupled to a port 112, the pressure difference generator 110 configured to generate the pressure. The port 112 may be part of a further structural member of the plurality of structural members.

FIG. 1C is a schematic showing different embodiments of the support structure 104. The holes of the support structure may be of any suitable shape and/or size. As shown in FIG. 1C, the holes may, for instance, be round, hexagonal, square, or irregular. The holes may be arranged in a regular array or in an irregular array, i.e. in a random manner. Each hole of the array of holes may have a shape such that a circle fitted into the shape touches at least three sides of the shape, while a radius (R) of the circle satisfies an equation R<σ×d×1.4/ΔP, wherein σ represent an ultimate tensile strength of the film 106, d represents a thickness of the film 106, and ΔP is a pressure differential across the film 106.

In various embodiments, the array of holes may occupy more than 50% of an area within the support structure 104.

FIG. 1D is a schematic illustrating the percentage of area occupied by holes in the support structure 104 according to various embodiments. The total area of the support structure 104 is provided by Aₛᵤₚₚₒᵣₜ, while the total area occupied by holes is given by the sum of A₁, A₂, A₃, and A₄. In various embodiments, the area A₁+A₂+A₃+A₄ may occupy any value above 50% relative to the total area of the support structure, i.e. Aₛᵤₚₚₒᵣₜ.

While FIG. 1D shows 4 holes, various embodiments may include any suitable number of holes.

Various embodiments may relate to a chamber in which a wall includes a sealed perforated structure covered by a film, e.g. a plastic film, thus reducing effective force on the chamber surface. The perforated structure may have an effective radius and geometry that match the film. The effective radius and geometry may be matched with a thickness of the film so that the film would not rupture due to pressure differences during operation.

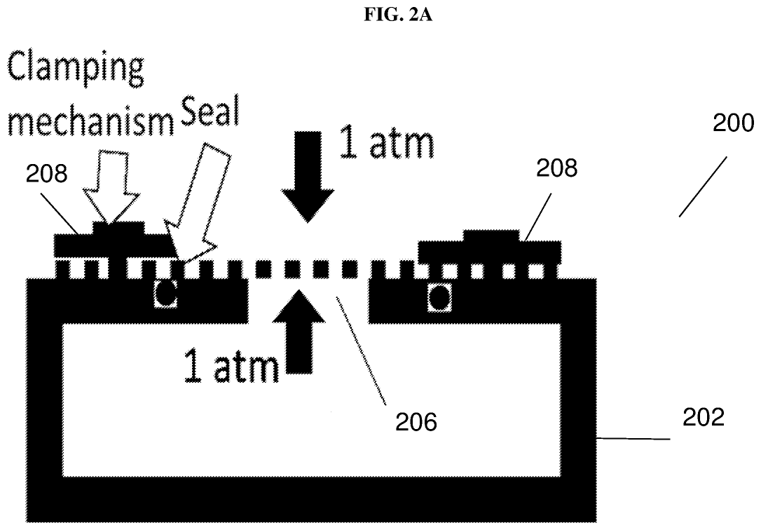

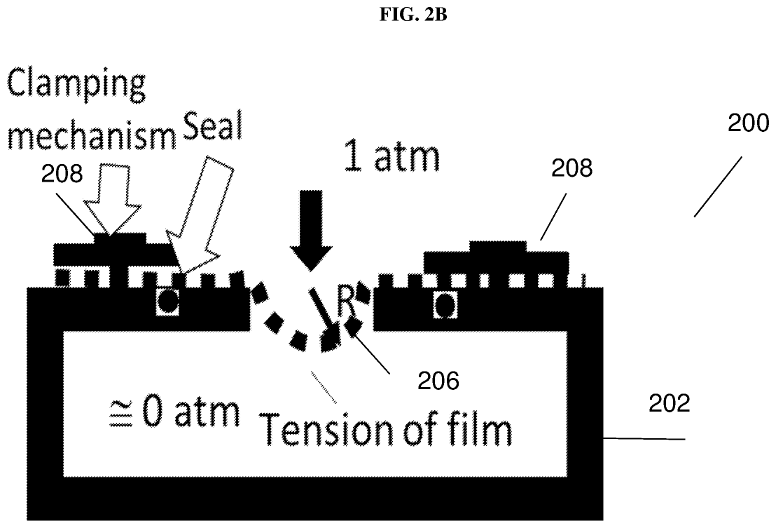

FIG. 2A is a schematic showing a chamber 200 according to various embodiments before vacuum is applied, i.e. when the pressure within the chamber 200 is equal to the external pressure. The chamber 200 may be defined by a plurality of walls 202, of which a wall of the plurality of walls includes a support structure including one or more holes, e.g. perforations. The chamber 200 may include a film 206 (of thickness t) placed over a hole or perforation in the wall of the chamber 200. The perforation may be of radius R. The film 206 may be sealed to the external surface of the wall. As shown in FIG. 2A, the film 206 may be approximately flat if tension is applied to the film 206 during sealing. The film 206 may be held by clamping mechanism 208.

FIG. 2B is a schematic showing the chamber 200 according to various embodiments after vacuum is applied within the chamber, i.e. when the pressure within the chamber 200 is less than the external pressure. As shown in FIG. 2B, the film 206 may experience a deformation (i.e. the film 206 is deflected towards or drawn/bent into the chamber 200) due to the pressure difference. The dimension and shape of the deformation may be a function of the film elastic and plastic properties, and may also depend on the perforation/hole geometry and final pressure difference. While FIGS. 2A-B show a single perforation, various embodiments may include any suitable number of holes or perforations.

It may be critical that the maximum strain on the plastic film 206 does not exceed the fracture or ultimate tensile stress limit. One may estimate the critical radius of perforation that prevent rapture, for example using clamped boundary conditions for membranes. For example, for a 100 μm thick polyethylene (PE) film, the critical radius of perforation based on clamped boundary conditions may be approximately 9.4 mm for a desired pressure difference of approximately 1 bar.

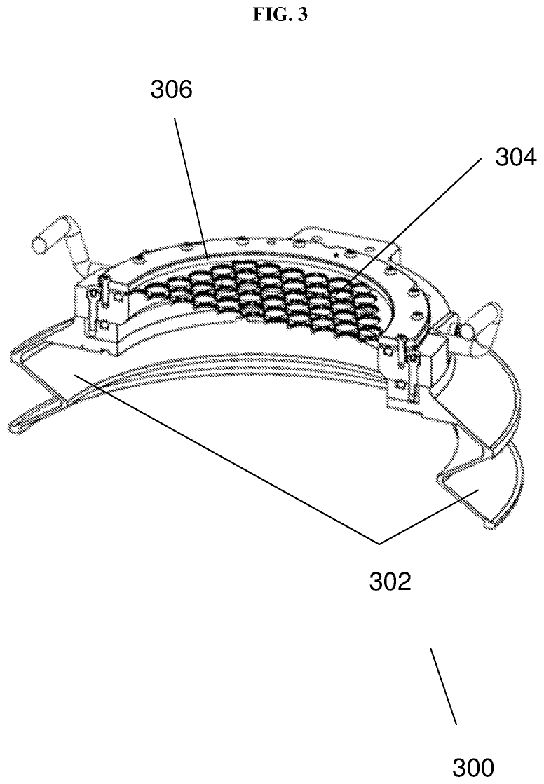

Various embodiments may be similar to the one shown in FIG. 3. In various embodiments, the support structure or portion supporting the plastic film may have an array of holes or perforations arranged in a predetermined pattern, e.g. a hexagonal pattern. Different radiuses of holes or perforations have been tested. It has been found that for 100 μm thick PE film, support structures or portions with perforations with radius of 15 mm or greater may lead to rapture, while support structures or portions with perforations with radius of 7.5 mm or smaller may not lead to rapture even after few months of vacuum cycling (i.e. turning the vacuum on and off). The high plasticity of the PE film may allow stretching up to 500% before break. Such a property may allow easy engineering of the film support structure and low cost production.

FIG. 3 is a schematic showing a part of an apparatus 300 according to various embodiments. The apparatus 300 may be a cover including a plurality of structural members 302. The plurality of structural members 302 may include a ceiling and one or more sidewalls joined to the ceiling. The ceiling of the cover may include a perforated support structure 304, and a film 306 attached to the perforated support structure 304.

A perforated support structure 304 may refer to a support portion including a plurality of perforations, i.e. holes extending from a first surface of the support portion to a second surface of the support portion opposite the first surface. In various embodiments, each perforation or hole may have a radius having any value selected from a range of 9.2 mm or smaller, e.g. 7.5 mm or smaller. The perforated support portion 304 may provide support for the film 306, and may allow a thin film to be used without rapturing.

The film 306 may be a polyethylene (PE) film. The polyethylene (PE) film may have transparency for a wide spectral range. The film 306 may have a thickness of any value selected from a range of from few μm to 300 μm, e.g. from 10 μm to 200 μm. A 12.5 μm thick PE thick film with 1.35 mm by 0.25 mm holes has been demonstrated. With a thick film, the transparency of the film may be reduced, while with a thin film, the chances of the film being raptured during operation may incease. A 100 μm thick PE film may be close to 90% transparent in a broad spectral range with just a few, narrow absorption peaks.

The apparatus 300 may further include a vacuum pump, coupled to the cover. The vacuum pump is not shown in FIG. 3. The cover may define an enclosed space when the cover is placed on a surface. When the cover is placed on the surface, the ceiling of the cover as well as sidewalls of the cover extending from the ceiling, may together with the surface, define the enclosed space. An enclosed space may alternatively be referred to as a chamber or compartment. The apparatus 300 may also include a pressure difference generator, e.g. an air compressor or a vacuum pump (not shown in FIG. 3) coupled or connected to the cover. A vacuum pump may be configured to generate a vacuum in the chamber, thereby decreasing a pressure in the chamber. A vacuum as referred herein may refer to a perfect vacuum or a partial vacuum. An air compressor may be configured to provide or supply pressurized air to the chamber, this increasing a pressure in the chamber.

In addition, the PE film may have low gas permeability. For example, in the worst case scenario for low density polyethylene (LDPE) film, the permeation coefficient may be below 70*10⁻¹⁰ cm/[cm³][cm]/[cm²][s][cmHg] ([volume of permeate][film thickness]/[film area][time][pressure drop across film]).

Assuming the pump has a power more than 400W, and a pumping rate >5 m³/hour=1400 cm³/s, the pressure difference of interest is 1 bar (75 cmHg), the film has a thickness of 100 um=0.01 cm, and assuming no leakage, the area of the film that can allow permeation of gas matching the pumping speed of the vacuum pump is more than 2500 m².

Various embodiments may be used in vacuum assisted thermography (VAT). In VAT, a local vacuum may be generated at the surface of a test structure or sample to excite thermal effects. One of such effects is low pressure induced boiling of water in ingresses. At low enough pressure (>30 mbar), water may boil at room temperature. Boiling is an energy intensive process. and even small quantities of boiled water may cause drastic cooling of the surrounding structure.

For a conventional VAT chamber, in order to achieve a large area of inspection, the objective may have to be placed further away from the surface. For an imaging area of approximately 150 mm in diameter, the working distance of the lens from the surface may be 300 mm away from the surface, assuming a standard objective lens is used for the camera. In order to maintain spatial resolution, the infrared (IR) camera may have to have a resolution of at least 640×480 pixels. This requirement may necessitate a relatively high-end camera with costs above $10,000. Also, the camera may be required to be permanently attached to the dome, which may be impractical as the camera may be required for other uses. A further issue with such design is that a large volume may be necessary to accommodate the working distance. This leads to two problems: (i) the unit is heavy >10 kg; and (ii) pumping time is long (>60 sec to set to a pressure of 30 mbar). A further increase in imaging area may only make these issues worse.

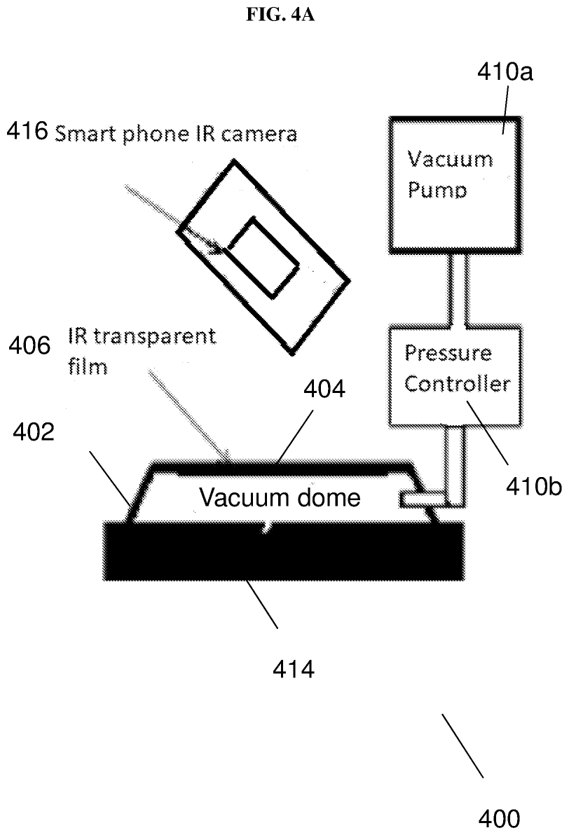

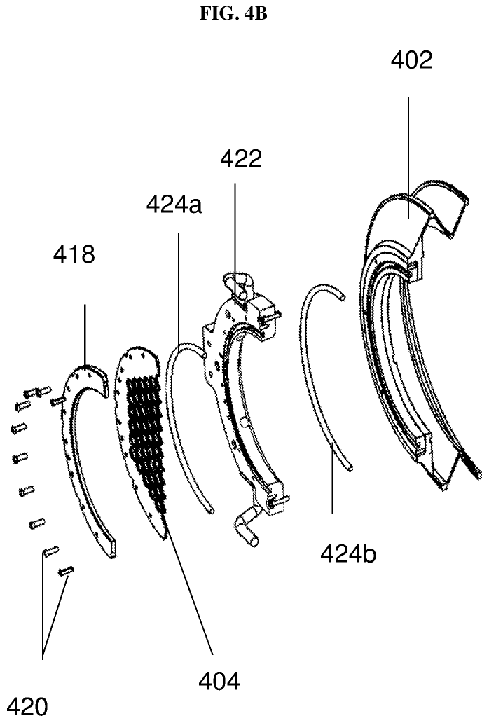

Various embodiments may relate to an apparatus for Vacuum Assisted Thermography (VAT). FIG. 4A is a schematic showing an apparatus 400 for Vacuum Assisted Thermography (VAT) of an object 414 according to various embodiments. The apparatus 400 may include a cover or vacuum dome configured to define an enclosed space with a surface of the object 414. The cover may include a plurality of structural members 402 coupled together to define the enclosed space.

The apparatus or chamber 400 may also include an vacuum pump 410a coupled to the cover or vacuum dome. The vacuum pump 410a may be configured to form a vacuum in the enclosed space or compartment, thereby decreasing a pressure in the enclosed space or compartment. The apparatus or chamber 400 may further include a pressure controller 410b coupling the vacuum pump 410a to the cover or vacuum dome.

An infrared detector 416, such as a smart phone infrared (IR) camera may be arranged or provided external to the cover or vacuum dome. One side of the cover or vacuum dome may include an infrared transparent film 406, such as polyethylene (PE). The cover or vacuum dome may include a support structure or portion 404 configured to support the infrared transparent film 406. The support structure or portion 404 may include an array of holes.

Defects or water ingress on the object 414 may be monitored via VAT using the infrared detector 416. The infrared radiation may travel from the object 414 through the vacuum and the film 406 to the infrared detector 416. Upon generating the vacuum, the portion of the object 414 with defects may cool at a faster rate than the portion of the object 414 without defects. By detecting the infrared radiation using the infrared camera, defects or water ingress on the object 414 may be observed.

FIG. 4B is a schematic showing an exploded view of a portion of the cover or vacuum dome according to various embodiments. The film 406 may be sandwiched between a compression plate 418 and the support structure or portion 404 of the dome. The dome may further include fasteners 420, e.g. screws, configured to hold the compression plate 418 to the support structure or portion 404. The dome may also include holder 422 configured to hold the compression plate 418 and the support structure or portion 404 to wall 402. The dome may also include seal or rubber rings 424a, 424b configured to reduce leakage.

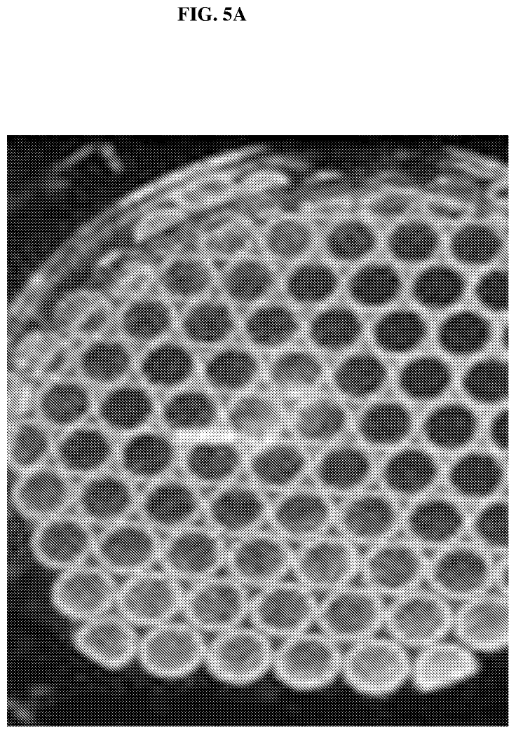

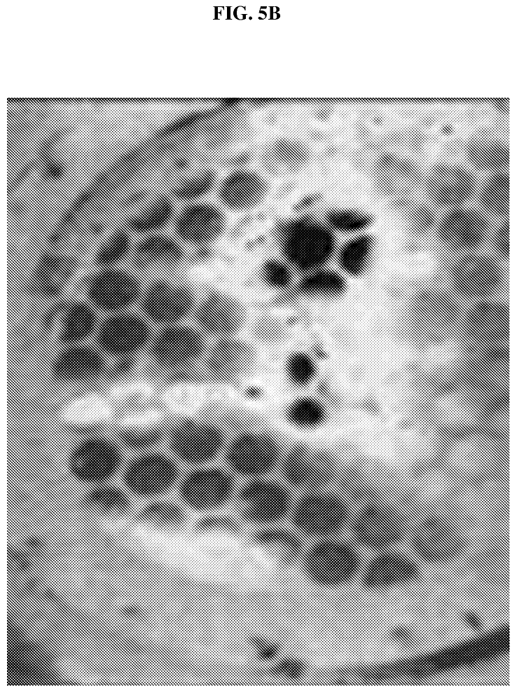

FIGS. 5A-B show an example of water ingress detection using Vacuum Assisted Thermography (VAT) based on the apparatus 400 shown in FIGS. 4A-B according to various embodiments. FIG. 5A is a thermal image of a sample with water ingress before vacuum pup is switched on. FIG. 5B is a thermal image of the same sample after vacuum level is atained, revealing distribution of sub-surface water ingress in the sample.

The apparatus 400 may result in cost reduction. Spatial resolution may be improved even with the use of a low resolution smartphone compatible IR camera (˜$1,000), because the camera can be brought to shorter working distances. In addition, the weight of the apparatus 500 may be reduced to below 3 kilograms (kg), which improves portability. Further, the evacuated volume may be reduced leading to pumping times of just 6 seconds (secs) for the vacuum to reach to 30 milibar (mbar). In addition, scaling up may be carried out without much difficulty.

Various embodiments may relate to a chamber in which a solid wall is replaced by a perforated structure (or a structure with holes) covered by a thin plastic film tightly clamped to the sealed perforated structure (or the structure with holes). In various embodiments, the film may be polyethylene (PE), especially in cases where high transparency of the chamber walls in visible and infrared spectra is necessary. The effective radius and geometry may be matched to the geometry of the film or a thickness of the film so as to prevent plastic rapture at the set pressure differences. The theoretical limit of the opening radius (R_{M}) for a 100 μm thick PE film may be about 9.2 mm. This computation may be based on clamped boundary conditions for a membrane stretched beyond the elastic limit. In various embodiments, the vacuum dome may have a large area and a low weight.

In various embodiments, the chamber may have a section, e.g. the film, having a thickness of 100 μm thick, leading to embodiments having high surface to weight ratios, and walls having multi-spectral transparency.

Various embodiments may be suitable for repair and inspection. Various embodiments may relate to an apparatus for out-of-autoclave repair of composite primary structures.

Porosity-free composite repairs are necessary during the lifespan of a primary load-bearing composite structure to address manufacturing defects, pre-service faults, in-service repairs and local structural modifications. As such, the term “composite repair” hereinafter may refer to these applications. Typical application areas utilizing lightweight primary composite structures are the aircraft and spacecraft sectors, with new applications also emerging in oil & gas, marine, transport and energy sectors.

Portable vacuum chambers that allow curing under atmospheric vacuum pressure have been previously proposed. However, the set-up may not be sufficient to create void-free composite patches or structures as explained below.

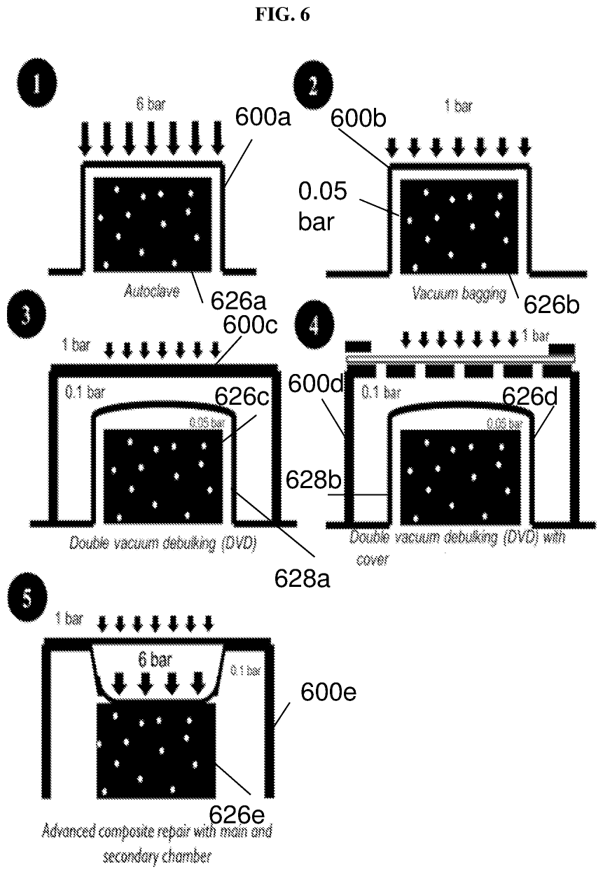

A porosity-free composite repair requires the precursor, namely carbon fibre prepreg, to be cured under vacuum and pressure. FIG. 6 is a schematic illustrating (1) a conventional autoclave 600a used for curing a composite patch or structure 626a, (2) a conventional vacuum bag 600b used for debulking a composite patch or structure 626b, (3) a conventional apparatus 600c used for double vacuum debulking (DVD) of a composite patch or structure 626c, (4) an apparatus 600d according to various embodiments used for double vacuum debulking (DVD) of a composite patch or structure 626d, and (5) an apparatus 600e according to various embodiments used for debulking and/or curing of a composite patch or structure 626e.

One method to cure fibre reinforced composite laminates is to use an autoclave 600a as shown in (1) of FIG. 6. An autoclave applies high positive pressures of up to 6 bar during the curing process to physically remove air and volatiles from the laminate. However, such an equipment would incur prohibitively high capital and tooling costs for many maintenance, repair and operations (MROs) companies and subcontractors. Furthermore, current composite aircraft have large sections that are bonded together, which make them impossible to dismantle and be repaired away from an aircraft hangar. Operating and maintaining an autoclave large enough to contain the entire aircraft is not economical for MRO companies. A more cost- and time-effective method to repair primary composite structures without an autoclave, and which still achieves quality results, is required.

Conventional methods involving the repair of primary composite structures (e.g. new generation aircrafts) in an out-of-autoclave setting involve a two stage process: (i) preparation of an uncured composite repair patch away from the structure in a humidity controlled room; and (ii) final co-curing of the patch with an adhesive film directly on the structure. The purpose of the separate patch preparation is to ensure a porosity-free composite or a composite which is less porous, as porosities reduce mechanical properties and affect fatigue performance

For step one, some conventional preparation methods may involve the use of a double vacuum debulking (DVD) process. The debulking process consolidates the layup, compacts thick laminates to remove the majority of the air or volatiles, ensures seating on the tool, and prevents wrinkles before the final cure. As shown in (2) of FIG. 6, debulking is often done under moderate heat, at up to 110° C., for 2 hours inside a vacuum bag 600b (maintained at absolute pressure between 50 millibar (mbar) and 150 mbar) that draws out all the volatiles from the patch 626b. This pre-cure stage is also known as B-staging in resin processing. The disadvantage of using a single vacuum bag 600b is that atmospheric pressure exerts a compacting force on the patch surface during the repair process, which hinders the debulking process.

The DVD process shown in (3) of FIG. 6 significantly reduces this compaction force on the primary vacuum bag such that the volatiles and reaction by-products can be evacuated under vacuum more reliably. This is achieved through application of a secondary portable vacuum chamber 600c on top of the lower vacuum bag (primary vacuum system) 628a. In a typical procedure, the absolute pressure is maintained at 0.05 bar and 0.1 bar in the lower (primary) and upper (secondary) vacuum systems respectively.

The DVD method uses conventionally available consumables and equipment. A rigid and strong box 600c is needed to form the vacuum chamber over the lower vacuum bag 628a. This allows for a shorter, less severe B-staging condition to be employed compared to a single vacuum bag debulking, hence better maintaining the composite's processability and fluidity. The DVD method allows preparation of a repair patch without use of an autoclave during cure.

Various embodiments may be used with a vacuum bag 628b for debulking of a patch 626d as shown in (4) of FIG. 6. As shown in (4) of FIG. 6, a vacuum bag 628b may be arranged or provided over the patch 626d. The apparatus 600d according to various embodiments may be provided or arranged on a surface and over the vacuum bag 628b, so that the apparatus 600d and the surface encloses the vacuum bag 628b and the patch 626d. The vacuum bag 628b may be coupled to a vacuum generator, so that the space within the bag 628 forms a first vacuum chamber, while the apparatus 600d may be coupled to another vacuum generator so that the space between the bag 628b and the apparatus 600d forms a second vacuum chamber. The first vacuum chamber may be maintained at a pressure lower compared to a pressure maintained in the second vacuum chamber. For instance, the first vacuum chamber may be kept at a pressure of 0.05 bar, while the second vacuum chamber may be kept at a pressure of 0.1 bar. The apparatus 600d may include a support structure with an array of holes and a film.

A method to combine the DVD process and the full cure process of the composite into a single sequence using an in-situ system has also been previously proposed. The method may reduce contamination and misalignment due to the removal of a manual handling step between the DVD process and the full cure process. The method may be achieved by building the DVD box/vacuum chamber over the repair area using solid or inflatable bladders. The positive pressure required during the full cure process may then be applied by inflating a second bladder located inside the DVD box. However, such a method uses a relatively heavy and rigid chamber design, hence limiting the applicability of the process to simple surface contours. Such a method may not easily work against gravity, e.g. in situations in which the underside of an aircraft requires repairing. Another method may use a rigid chamber with a viewing window. It is conceivable that the dimensions required to withstand the pressures would make the apparatus incredibly heavy.

Further, methods of achieving low porosity by increasing pressure applied to the composite part during curing have also been proposed. The higher pressure may be enough to force the volatiles out during the cure process in a similar manner as an autoclave would. Again, these methods would require heavy and rigid apparatuses.

A problem encountered with the existing DVD processes is the long set up time to establish a vacuum environment in both the upper and lower vacuum bagging systems. The preparation time is at least 60 minutes which includes the cutting of each item in the lay-up, assembling of the lay-up, sealing of the lower vacuum bag assembly, leak testing and subsequent rectifying and positioning of the DVD box, second sealing and leak testing of the upper vacuum bag assembly. The set up may then be followed by the B-stage heating step that can take up to 2 hours. In addition, the DVD and full cure processes may require a significant quantity of single use consumables. These can add up to significant costs and time spent.

Furthermore, the commonly accepted DVD box design used in the aerospace industry, may be a rigid structure made of plywood (single use) or aluminium (multiple use). The DVD box may thus inherently be heavy as it is reinforced to prevent implosion of the vacuum chamber. The weight of the DVD box may increase as a function of the repair radius squared, making large repairs become increasingly more labour intensive. For a repair size of Ø150 mm, a suitably sized aluminium DVD box may weigh about 18 kg. This is sufficiently heavy and may require two persons to carry and position.

Commercially available DVD chambers are also available in the market. For example, the DVD chamber from Heatcon is a large unit with a working size of 1 m×1 m, costs approximately US$60,000 and is heavy enough that it requires pneumatic support to lift the chamber. Nonetheless, it also has the same problem of long set up times as it uses conventional methods in setting up. A method may involve the use of a solid plastic sheet (Lexan) without a perforated reinforcement portion for visible and infrared transmissions. This may result in the requirement for a much thicker sheet of plastic (˜20 mm vs 0.1 mm) for the same vacuum pressure.

The second problem commonly encountered in the repair process lies in the transport of the patch from the laboratory to the site of the repair (e.g. aircraft hangar), which usually involves the patch being exposed to the environment. In Singapore, these conditions can reach a temperature of 32° C. and a relative humidity (RH) of 95%. The inventors found that the B-staged patch may absorb enough moisture after only 30 minutes at these conditions for porosities to develop during the full cure process, thus subsequently failing the repair. Ultrasonic testing (C-scan) were performed on such samples and it was clear that exposure to such environments render substantial porosity in the repair. A duration of 30 minutes is comparable to the time required to establish a vacuum environment in the full cure set-up. A temperature and humidity-conditioned temporary structure can be constructed around the repair structure. However, this adds a significant cost to the repair process.

An in-situ, combined DVD and full cure process that can alleviate the second problem of moisture absorption has been proposed. However, the proposed method still has the same problem of a long set up time, mainly attributed to the prevention of vacuum leakage. The method would also be difficult to perform upside down due to the weight of the chamber design, which would be necessary for damage repair on the underside of an aircraft. Additionally, the application of positive pressure (i.e. above atmospheric) is not possible using this set-up. Finally, the strongback tool used as the top cover of the DVD box may need to be of the same or similar contour to the parent structure, which requires costly tool adaption to individual repair sites.

Another problem encountered in out-of-autoclave prepreg processing relates to external pressure application on the composite. The conventional full cure layup applies a constant pressure of 1 atmosphere on the composite. This is low compared to an autoclave, where pressures up to 6 bar are commonly employed. A phenomenon observed in out-of-autoclave composite repairs without positive pressure is the formation of voids due to desorption of carbon dioxide (CO₂) from the resin which contains amine based curing agents. Amine compounds can absorb CO₂ at ambient temperatures, a feature commonly exploited to remove CO₂ from fuel and combustion gas. The reversible desorption process occurs at 120° C. (above the acceptable DVD process temperature). High pressures may be required to physically force the volatiles out. Indeed, CO₂ release was detected for the adhesive film using thermal gravimetric mass spectrometry (TG-MS) at a temperature of 140° C. The result of this effect is the potential formation of porosities even after the DVD process has been conducted.

Besides providing the force to push volatiles out, high pressures may also reduce fibre waviness. This may be beneficial in improving tensile properties, reducing fibre print-through and increasing patch conformity, thus reducing necessary post-processing of the repaired composite parts such as sanding or coatings to ensure a smooth aircraft surface.

Previous methods achieve this by (a) stacking a large number of metal plates of the same contour and decreasing surface area to the parent structure or (b) inflating a flexible pressure bladder while supporting its solid cover with suction devices. These features cause the systems to be heavy, highly specific to the contour of the structure, and cumbersome to set-up due to the large number of individual parts. The weight increases linearly with the repair area, and is challenging to perform repairs to the lower side of structures. It may also be infeasible that large pressure differences may be applied between chambers due to weight reasons.

Current apparatuses and methods do not address the long thermal survey times typically encountered in industry. The thermal surveys are conducted before final curing to ensure that the cure cycles can reach their desired temperatures with minimal temperature variation across the heated area. This process can take several days depending on the complexity of the underlying structure, e.g. struts, support beams behind the laminates. The maximum allowable thermal survey time set by the original equipment manufacturers (OEMs) are typically in the order of 24 hours, beyond which a larger area may be required to be removed.

Various embodiments may relate to an apparatus 600e integrating DVD and curing as shown in (5) of FIG. 6. The apparatus 600e may address or mitigate one or more problems as described above. The apparatus 600e may be arranged on a surface so that a patch 626e arranged on the surface is enclosed by the apparatus 600e and the surface. The apparatus 600e may be separated into a main chamber and a secondary chamber within the main chamber as shown in FIG. 6. The patch 626e may be within the main chamber. The apparatus 600e may include partition walls and a sealing film separating the main chamber and the secondary chamber. The apparatus 600 may be suitable for DVD and curing. During DVD, the main and secondary chambers may be at pressures lower than atmospheric pressures so that volatiles from the patch 626e may be drawn into the main chamber, and the sealing film deflects into the secondary chamber. During curing, pressurized air may be provided or supplied to the secondary chamber, thereby compressing the patch 626e to push volatiles out, thereby reducing formation of porosities.

As highlighted above, various embodiments may relate to an apparatus that can be used in an integrated DVD and curing setup or a DVD setup. Various embodiments may also be used in a curing setup. The apparatus may be set up in-situ on the object to be repaired. Various embodiments may be used as an alternative to the current methods and apparatuses described above. Various embodiments may be used in the aircraft MRO industry. Various embodiments may also be used in other industry sectors that require use of high-end composite structures.

The apparatus shown in FIG. 3 or (4) of FIG. 6 may be used or adapted as a DVD setup. In various embodiments, the cover may define a vacuum chamber or half-chamber. The chambers may be extremely light and portable (few kilograms (kg) for large area unit) and may achieve vacuum levels down to a few millibar. Synergistic effects of the perforation design and PE film may be achieved. The film may be stretched over the perforated support portion to increase the surface area. The film and the perforated support portion may allow the cover to be thinner, hence lighter, while achieving the same effect.

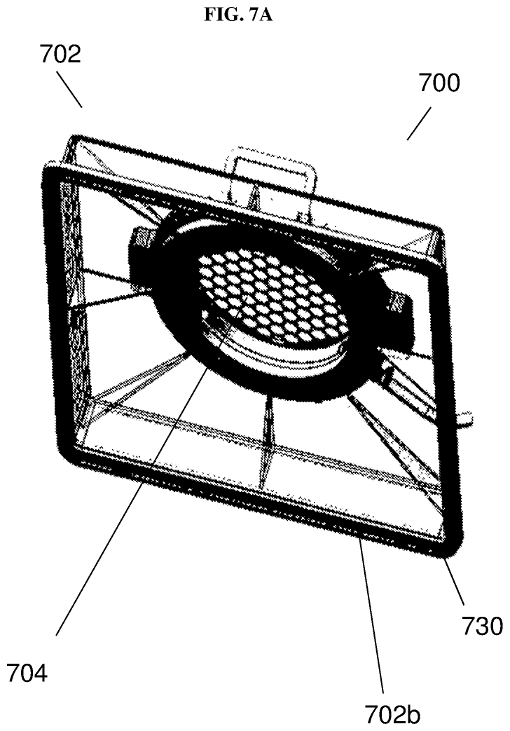

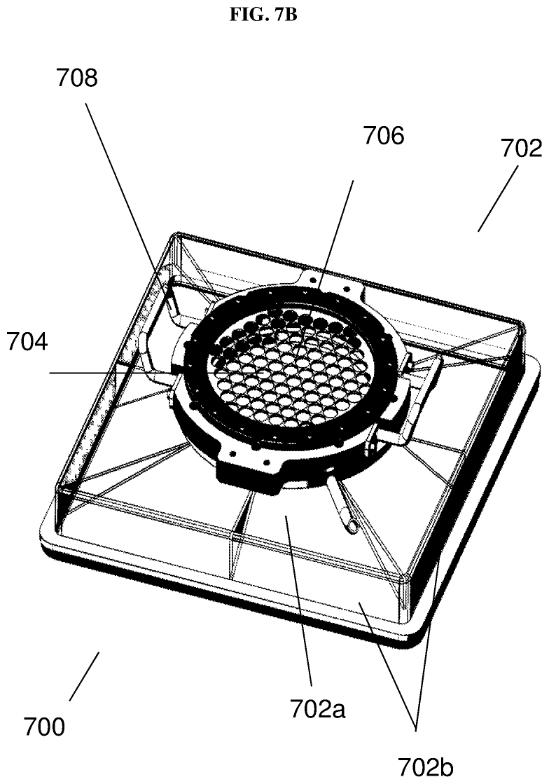

FIG. 7A is a schematic showing a back view of an apparatus 700 for in-situ repair of an object according to various embodiments. FIG. 7B shows a perspective view of the apparatus 700 according to various embodiments. The apparatus 700 include a cover 702. The cover 702 may include one or more structural members such as a support structure 704 including an array of holes, a ceiling 702a surrounding the support structure 704, and side walls 702b joined to the ceiling 702a. The support structure 704, the ceiling 702a, and the side walls 702b may at least partially define a compartment or chamber. When the apparatus 700 or cover 702 is placed on a surface, e.g. a surface of the object to be repaired, the ceiling 702a and the side walls 702b may, together with the surface, define a chamber or compartment. The apparatus may further include a vacuum pump (not shown in FIGS. 7A-B) coupled to the cover 702. The vacuum pump may be configured to generate a vacuum in the compartment, thereby changing, i.e. decreasing, a pressure in the compartment. A film 706, e.g. a polyethylene (PE) film, may be attached to the ceiling 702a such that it stretches across the support structure 704. The film 706 may be configured to allow a predetermined range of wavelengths of electromagnetic waves to pass through. For instance, the film may be configured to allow at least a portion of infrared light and at least a portion of visible light to pass through. The apparatus 700 may be configured to debulk the patch.

The cover 702 may be a machined aluminum enclosure. The cover 702 may be arranged on a surface in which the composite patch (not shown in FIGS. 7A-B) is arranged on. The enclosure may have a slot for holding a sealing rubber 730 made of foam material for conforming to the irregularities on the surface in which the cover 702 is arranged on. The sealing rubber 730 may be attached to the cover 702, i.e. to end portions of the side walls 702b. The sealing rubber 730 may allow sealing of even 2 mm high irregularities on the surface hosting the composite patch.

In various embodiments, the apparatus 700 may also include a heat blanket and/or one or more thermocouples (also not shown in FIGS. 7A-B) arranged in the chamber or compartment. The sealing rubber 730 may allow electrical connections or wires for the heat blanket and the thermocouples to extend from within the cover 702 to outside of the cover 702. In various embodiments, a special vacuum port for wires may be incorporated into the enclosure body. In various embodiments, the enclosure may have a central viewing port of 200 mm diameter. 8 stiffeners may be incorporated in the viewing port to redistribute the pressure from the center of the enclosure to the edge of the enclosure, thus reducing structural bending and leaks due to the bending.

As highlighted above, a film 706, such as a plastic film, may be arranged on the support structure 704, e.g. a perforated plate. The perforated plate may be matched to the aluminum enclosure and may be sealed using rubber O-rings. In various embodiments, the perforated plate may be a steel plate having a thickness of 2 mm The perforations may be circular perforations arranged in a hexagonal pattern across the plate. The film 706 may be a 100 μm thick PE film. Apart from maintaining vacuum, the PE film may allow the observation of phenomenon within the enclosure in the visible and IR spectral ranges. The PE film may facilitate the monitoring of the debulking process, particularly in observing any potential fractures of the primary vacuum bag. The PE film may also allow observing of the heat distribution generated by the heat blanket.

There may be no practical limit for the area coverage of the support unit. The permeability of air through the PE film may be very low, and the required vacuum may be maintained even for a unit covering 2000 m² area, assuming that all other leaks are negligible. The total weight of the 400 mm by 400 mm unit may be light, e.g. 3.5 kg. The weight may be even lower if the PE film covers the whole area of the ceiling instead of just the middle portion. In various embodiments, perforations may be directly introduced into machined aluminum enclosure.

The apparatus may be able to pull down to 20 mbar vacuum pressure in less than 1 minute, even though the wires for the heat blanket and thermocouples were passed under the foam rubber sealer.

In comparison, a conventional enclosure weighs 25 kg and is not capable of achieving such low vacuum levels. The presence of appreciable leaks also leads to long pumping times of up to 1 hour before the system is ready. Further, the conventional enclosure requires new vacuum seal tape to be applied for every new experiment. It is a costly and tedious process which requires experience in order to achieve good sealing and pass leak test requirements. On the other hand, various embodiments may be completely reusable and may be placed over a patch without prior preparation.

The cover may weigh less than 3 kg. Further, the apparatus may require only one person to operate, and may reach a vacuum of 30 mbar within 1 minute. In addition, observation of the compartment may be possible through most of the top surface. The apparatus may also be easily scalable, and may require minimum consumables. In contrast, a conventional DVD apparatus may weigh 25-80 kg, may require two people to operate, may only reach a pressure greater than 60 mbar after 30 minutes, may have limited side observation window, may not be scalable, and may require a lot of consumables.

Table 1 shows advantages and benefits of various embodiments in relation to a conventional double vacuum debulking (DVD) apparatus.

TABLE 1
Key advantages and benefits of various embodiments over a conventional double
vacuum debulking (DVD) apparatus

| | Conventional | Various | |
|---|---|---|---|
| | DVD apparatus | embodiments | Description |
| Specification | | | |
| Weight for 500 mm × | 25 kg | 7 kg | Light enough for 1 person to carry |
| 500 mm | | | |
| Compliant with structural | Yes | Yes | No need for further certification |
| repair manual (SRM) | | | |
| Window | No | Yes | Can observe inside for film puncture |
| Thermal visibility | No | Yes | Able to use IR camera to check |
| | | | temperature profile |
| Curvature compliance | No | Yes | Suitable for slight curvatures e.g. |
| | | | fuselage |
| Chamber alignment | Yes | No | Standard DVD need to align hole for |
| requirement | | | cable pass-through |
| Force required to achieve | High | Low | High = at least 2 persons pushing |
| initial vacuum seal | | | down for Standard DVD |
| Vacuum failure points | 2 (vacuum bag | 1 (PE film | For standard DVD, cannot check for |
| | puncture and | puncture) | puncture during process. If puncture, |
| | cable pass- | | need to redo process from scratch. |
| | through) | | For standard DVD, cable pass- |
| | | | through point prone to failure and |
| | | | vacuum leakage. |
| | | | For new DVD, 5 min replacement if |
| | | | fail. |
| Man-power | | | |
| # of Staff | >2 | 1 | |
| Time to achieve vacuum | ~20 mins | <1 min | Time spent sealing edges and cable |
| seal | | | pass-through hole |
| Set-up time | 60 mins | 3 mins | Time spent on sealing and leak test |
| Vacuum leakage | 3 mins | >10 mins | Time to lose vacuum (gain absolute |
| | | | pressure) by 1 inHg (34 mbar) |
| Total process time | Up to 4 hrs | 2 hrs | Large leak values in Standard DVD |
| | | | leads to poor stability of pressure |
| | | | differential. New DVD capitalizing on |
| | | | foam rubber seal at the edges. |
| Consumables | | | |
| Vacuum bags | 4 m² | 1 m² | $1,000/100 m² roll |
| Breathers | 3 m² | 1 m² | $500/100 m² roll |
| Sealant tape | 10 m | 4 m | $1,000/300 m |

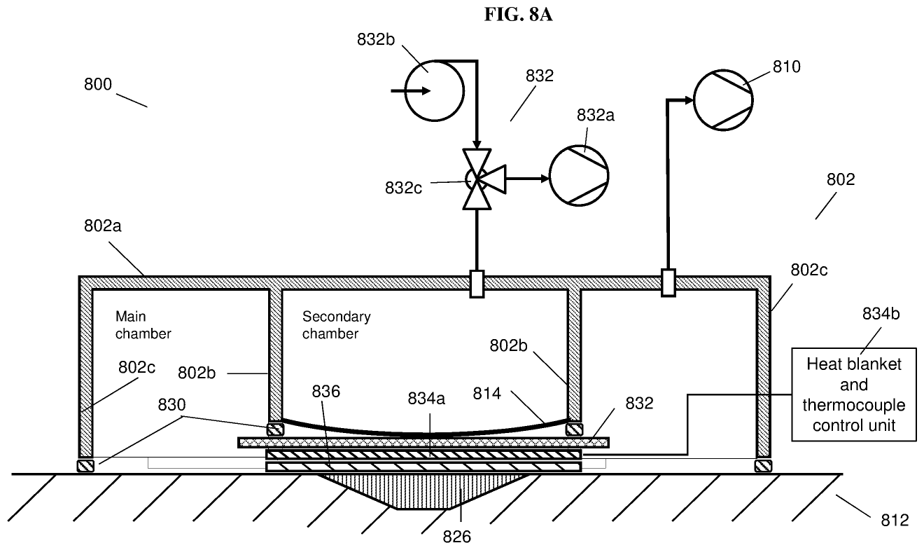

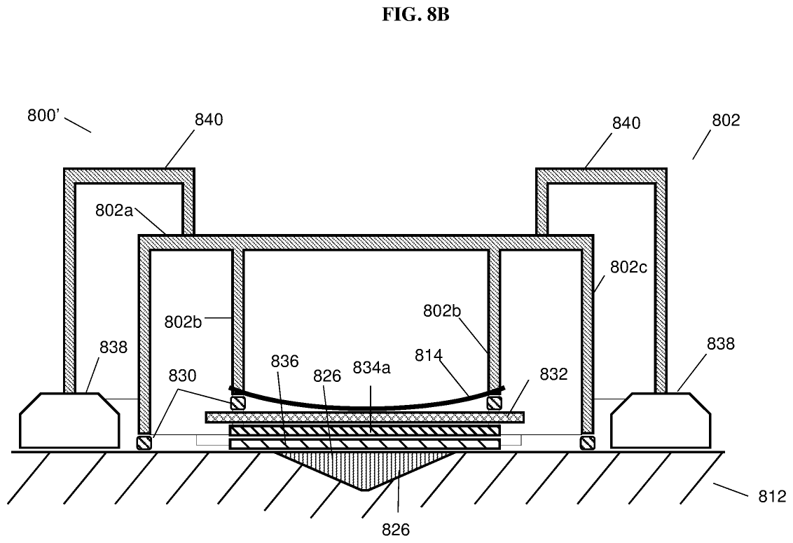

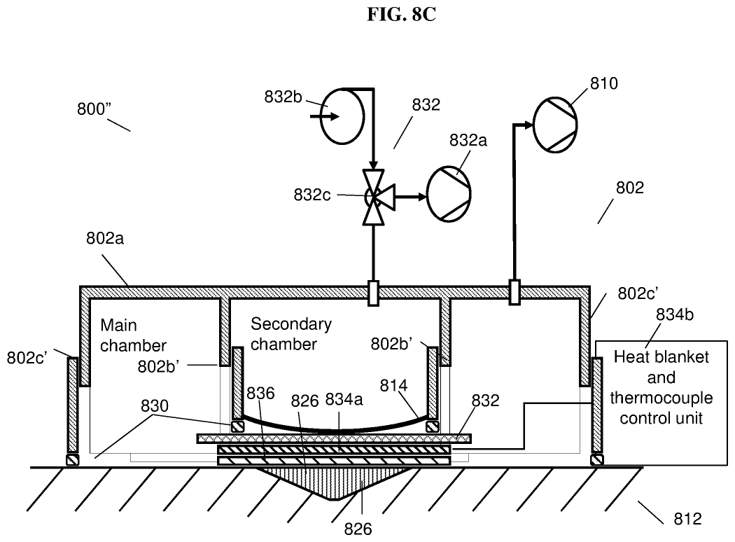

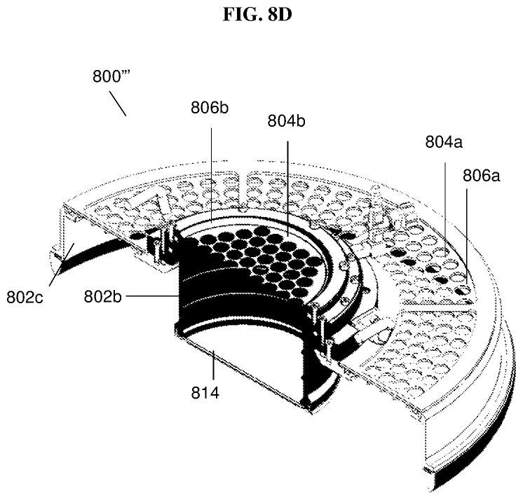

FIG. 8A is a cross-sectional schematic showing an apparatus 800 according to various embodiments for in-situ repair of an object 812. The object 812 may be the object to be repaired, and may for instance be a hull of an aircraft, a part of a ship. The apparatus 800 may include a cover 802. The cover 802 may include a ceiling 802a, one or more partition walls 802b joined to or extending from the ceiling 802a, as well as one or more side walls 802c joined to or extending from the ceiling 802a. The apparatus 800 may also include a sealing film 814, such that the sealing film 814, the ceiling 802a, and the one or more partition walls 802b define an inner compartment (i.e. secondary chamber). The one or more side walls 802c, the ceiling 802a, and the one or more partition walls 802b may, together with the surface of the object 812, further define an outer compartment (i.e. main chamber) when the apparatus 800 is placed on the object 812.

The side walls 802c and/or partition walls 802b may be solid, or may be configured to slide for easy matching to the substrate height or to accommodate irregularities. Each of the one or more side walls 802c and/or each of the one or more partition walls 802b may include a first wall portion, a second wall portion, and an adjustment mechanism, such as a sliding mechanism, configured to adjust a relative position of the first wall portion and the second wall position, thereby adjusting a height of the side wall/partition wall.

The cover may or may not include a support structure including an array of holes, and a film attached to the support structure. The film may be a PE film, and may be stretched across the support structure. Accordingly, a cover including the support structure and the film may allow at least a portion of visible light and at least a portion of infrared light may travel between the main chamber (and/or the secondary chamber) and the external enviroment. A detector or an observer may thus detect or observe the inner compartment through the film and the support structure. Accordingly, the debulking and/or the curing of the patch 826 may be monitored.

The apparatus may further include a pressure difference generator 832 coupled to the cover 802. The pressure difference generator 832 may be a system including a vacuum pump 832a, an air compressor 832b, and a switch 832c. The pressure difference generator 832 may be configured to change a pressure in the inner compartment. The pressure difference generator 832 may be configured to switch between providing a pressure lower than the atmospheric pressure (e.g. by generating a vacuum) and providing a pressure higher than atmospheric pressure (e.g. by providing pressurized air) to the inner compartment.

As highlighted above, the pressure difference generator 832 may include a vacuum pump 832a configured to generate a vacuum in the inner compartment, thereby changing the pressure in the inner compartment, i.e. decreasing the pressure in the inner compartment. The pressure difference generator 832 may also include an air compressor 832b configured to provide pressurized air to the inner compartment, thereby changing the pressure in the inner compartment, i.e. increasing the pressure in the inner compartment. The pressure difference generator 832 may further include a switch 832. The switch 832c may be configured to switch between a first state, which allows the vacuum pump to generate the vacuum in the inner compartment, and a second state, which allows the air compressor to provide the pressurized air to the inner compartment. The switch 832c may be configured to couple or connect the vacuum pump 832a to the inner compartment and disconnect or uncouple the air compressor 832b from the inner compartment when the switch 832c is in the first state. The switch 832c may be further configured to disconnect or uncouple the vacuum pump 832a from the inner compartment and couple or connect the air compressor 832b to the inner compartment when the switch in the second state.

The apparatus 800 may also include a vacuum pump 810 coupled to the outer compartment (main chamber), the vacuum pump 810 configured to generate a vacuum in the outer compartment.

The sealing film 814 may be configured to be coupled to a patch 826 for in-situ repair of an object. The sealing film 814 may be configured to provide a compression force on the patch upon the air compressor 832b providing the pressurized air to the inner compartment, e.g. during curing of the patch 826. When the pressurized air is provided to the inner compartment, the pressure in the inner compartment may increase and the sealing film 814 may be pushed against the patch, thus applying the compression force to the patch. Accordingly, the inner compartment may be used to compress the patch by applying high pressure.

On the other hand, the sealing film 814 may be configured to be deflected towards or drawn into the inner compartment upon the vacuum pump 832a generating the vacuum in the inner compartment. In other words, the sealing film 814 may be bent or directed away from the patch 826 when the vacuum is generated in the inner compartment. When the vacuum is generated, pressure in the inner compartment may decrease, and the sealing film may be pulled away from the sealing film. One or more volatile substances may then be drawn from the patch 826 to the outer compartment when the vacuum is generated in the outer compartment (main chamber). Debulking of the patch 826 may thus be carried out.

The debulking process may work without using the lower vacuum bagging setup as per the traditional DVD process, but the bag can be reintroduced without detrimental effects to the whole concept if necessary. The apparatus may also include a ring at the bottom of the inner compartment securing the sealing film 814 such that that the inner compartment is hermetically isolated from outer compartment. The sealing film 814 may be a nylon film. Accordingly, the pressure inside the inner compartment may be varied on demand, independent of the presure of the outer compartment. The inner compartment may be evacuated for the DVD process or may be pressurized for the curing of the patch.

The apparatus 800 may also include a breather layer 832, and/or a foam rubber spacer 830 coupled to the partition walls 802b, the breather layer 832 and/or the foam rubber spacer 830 configured to allow the volatile substances to be drawn from the patch 826 into the vacuum generated in the outer compartment. The foam rubber spacers 830 may also help keep the patch 826 in place during the process. The apparatus 800 may further include a foam rubber spacer 830 at an end portion of each of the side walls 802c. The foam rubber spacers 830 may be suitable to be used at high temperatures.

The apparatus 800 may further include a heat blanket layer 834a coupled to the breather layer 832 or the foam rubber spacer 830. The heat blanket 834a may include a heat transfer fluid, such as water or silicone oil. The apparatus 800 may also include a control unit 834b. The control unit 834b may be in electrical connection with the heat blanket 834a and one or more thermocouples. One or more thermocouples may be configured to detect a temperature of the heat blanket 834a or the patch 826. The control unit 834b may be configured to adjust or control the temperature of the heat blanket 834a based on the temperature detected by the one or more thermocouples. The control unit 834b may be configured to compare the detected temperature with a predetermined desired temperature, and may be further configured to adjust or control the temperature of the heat blanket 834a based on the comparison. For instance, if the detected temperature is lower than the predetermined desired temperature, the control unit 834b may control the heat blanket to increase the temperature of the heat blanket 834a. On the other hand, if the detected temperature is higher than the predetermined desired temperature, the control unit 834b may control the heat blanket 834a, e.g. switch off the heat blanket 834a, to decrease the temperature of the heat blanket 834a.

The apparatus 800 may also include a release film 836 configured to contact the patch 826. The release film 836 may be non-porous. The release film 836 may include a first surface contacting the patch 826, and a second surface opposite the first surface contacting the heat blanket 834a.

The sealing film 814, the heat blanket 834a, the breather layer 832, and/or the release film 836 may be made permanent parts of the apparatus 800, such that consumables may no longer be required for the DVD and cure processes. The permanent setup may include the sealing film 814, the breather layer 832, heat blanket 834a and non-porous release film 836 secured or coupled to the bottom of the inner compartment. The foam rubber spacers 830 may not be required when the apparatus 800 includes the breather layer 832 because the breather layer 832 may already be sufficient to allow the volatile substances to escape.

The maximum pressure inside the inner compartment may be proportional to the area of the main box top surface (pressed to structure by atmosphere) and may be inversely proportional to the area of the plastic film 836 pressing on the patch 826. For example, compressing a patch of 200 mm diameter with a pressure of 6 bar may require a main box coverage area of at least 1 m in diameter. For increased safety measures, when positive pressure is required to be applied in the inner compartment, additional vacuum pads or cups may be included. The vacuum pads or cups may be rigidly attached to the main box. The light weight and single-unit design of the apparatus 800 may also allow for easier attachment against gravity on the lower side of any overhanging composite structure. An example would be the bottom of an aircraft fuselage, which is prone to damage from debris during takeoff and landing and may thus require structural repair.

FIG. 8B is a cross-sectional schematic showing an apparatus 800′ according to various embodiments. The apparatus 800′ may be similar to the apparatus 800 shown in FIG. 8A, but may further include vacuum cups or pads 838.

The apparatus 800 may include a plurality of vacuum cups or pads 838 configured to attach to the object 812, and a plurality of rigid arms 840, each arm of the plurality of rigid arms 840 joining a respective vacuum cup or pad of the plurality of vacuum cups or 838 to the ceiling 802a of the apparatus 800. The number of vacuum cups or pads 838 required around the periphery may be dependent on the surface area required for force balance.

For large patches on curved surfaces, the soft foam rubber spacers may be replaced with a certain type of vacuum cup or pad with bellows. Alternatively, the walls 802b, 802c of the apparatus 800 may each be a composite structure including rubber (e.g. polydimethylsiloxane (PDMS)) and metal inserts (e.g. aluminium).

FIG. 8C is a cross-sectional schematic showing the apparatus 800″ with an adjustment mechanism according to various embodiments. As shown in FIG. 8C, the walls 802b′, 802c′may be similar to walls 802b, 802c shown in FIG. 8A, but which may include an adjustment mechanism.

In various embodiments and as highlighted above, each partition wall 802b′ and/or each side wall 802c′ may include an adjustment mechanism include hinges, bistable walls, or spring-loaded sections so that the walls 802b′/802c′ may be conformable and self-aligning to various shapes of the object 812.

FIG. 8D is a schematic showing a perspective view of the apparatus 800′″ shown in according to various embodiments. The apparatus 800′″ may include side walls 802c. The apparatus 800′″ may also include partition walls 802b to separate the main chamber and the secondary chamber as shown in FIG. 8A. The apparatus 800′″ may also include the sealing film 814 stretched between end portions of the partition walls 802b. The apparatus may include a first support portion 804a (including an array of holes) joining the partition walls 802b and the side walls 802c to at least partially define the main chamber, and a second support portion 804b (including an array of holes) joining the partition walls 802b to define the secondary chamber with the partition walls 802b and the sealing film 814. A first transparent film 806a may cover the first support portion 804a, and a second transparent film 806b may cover the second support portion 804b.

Various embodiments as highlighted above may relate to an apparatus which is light, which allows the debulking process to be carried out directly on the structure to be repaired, which can conform to general surface shapes, which allows the application of a positive pressure, and which allows the final full cure process to be carried out without taking the patch out of the enclosure. The synergy observed in negative pressure may also be exploited with positive pressure, with minimal increase to the weight, to achieve significantly improved composite repair performance, which may only be achieved in an autoclave.

Various embodiments may also relate to an apparatus including only an inner compartment, i.e. the second chamber. In some applications, only the pressurized function may be required.

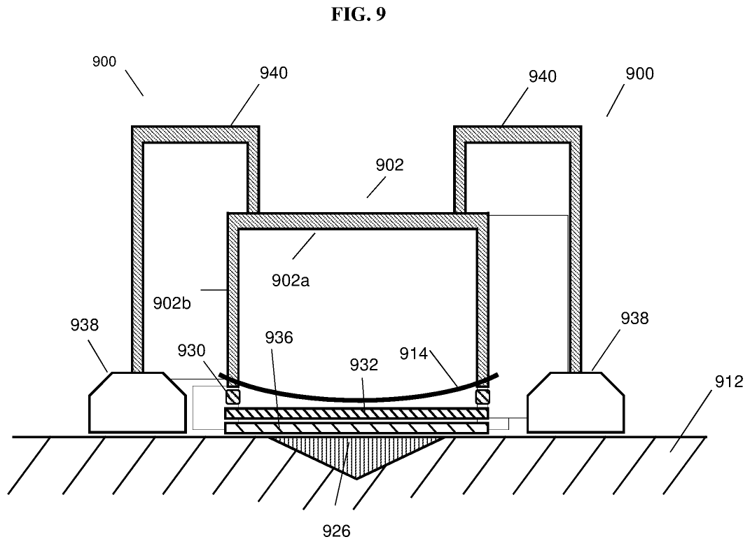

FIG. 9 is a cross-sectional schematic showing an apparatus 900 according to various embodiments for in-situ repair of an object 912.

The apparatus 900 may include a cover 902. The cover 902 may include a ceiling 902a, and one or more side walls 902b joined to or extending from the ceiling 902a. The apparatus 900 may also include a sealing film 914, such that the sealing film 914, the ceiling 902a, and the one or more side walls 902b define a compartment or chamber.

The ceiling 902a may include a support portion structure including an array of holes, and a film stretched across the support portion structure. The film 906 may be a PE film, and may be stretched across the support portion structure. Accordingly, at least a portion of visible light and at least a portion of infrared light may travel between the compartment and the external enviroment. A detector or an observer may thus detect or observe the compartment through the film and the support portion structure. Accordingly, the curing of the patch 926 may be monitored.

In various embodiments, the apparatus 900 may further include an air compressor (not shown in FIG. 9). The air compressor may be configured to provide a pressure higher than atmospheric pressure (e.g. by providing pressurized air) to the compartment. In various other embodiments, the apparatus 900 may include a pressure difference generator including a vacuum pump, an air compressor, and a switch similar to that shown in FIG. 8A.

The apparatus 900 may also include a sealing rubber structure such as a foam rubber spacer 930 coupled to each side wall 902b. The apparatus 900 may further include a heat blanket layer 932 coupled to the foam rubber spacers 930. In addition, the apparatus may also include a control unit (not shown in FIG. 9) coupled to the heat blanket layer 932.

The apparatus 900 may also include a release film 936 configured to contact the patch 926. The release film 932 may be non-porous. The release film 936 may include a first surface contacting the patch 926, and a second surface opposite the first surface contacting the heat blanket 932.

The apparatus 900 may include a plurality of vacuum cups or pads 938 configured to attach to the object 912, and a plurality of rigid arms 940, each arm of the plurality of rigid arms 940 joining a respective vacuum cup or pad of the plurality of vacuum cups or pads 938 to the ceiling 902a of the apparatus 900. In other words, the apparatus may include a set of vacuum cups or pads 938 rigidly connected to a stand-alone compartment or chamber. Due to the structure's lightweight nature, installation may be simple and may again also be carried out on vertical and overhanging surfaces. The apparatus may be particularly useful for large area curved or complex geometry surfaces.

The method of delivering heat to the patch may also be further improved by exploiting the pressurized inner compartment. An internally or externally heated heat transfer fluid (such as water or silicone oil) may be charged into the inner compartment after the DVD process for the full cure and used as the heat source, effectively replacing the heat blanket.

Various embodiments may include a heat transfer fluid filled silicone heat blanket situated above the sealing film. The heat transfer fluid filled silicone heat blanket may have the advantage of acting as a large heat sink to counteract temperature fluctuations due to excess heat generated or a heat source to counteract heat loss due to conduction away by other parts of the object, e.g. non-uniform stringer arrangements behind the primary structure.

Various embodiments may help to shorten the thermal survey step, which typically takes 24 to 48 man-hours to successfully complete. Additionally, the ramp rate when using a heat transfer fluid may be significantly increased if the heat transfer fluid is externally heated. Various embodiments may relate to an apparatus including the heating unit into the structure such that there is no need to manually handle the rather cumbersome and heavy liquid filled heat blanket.

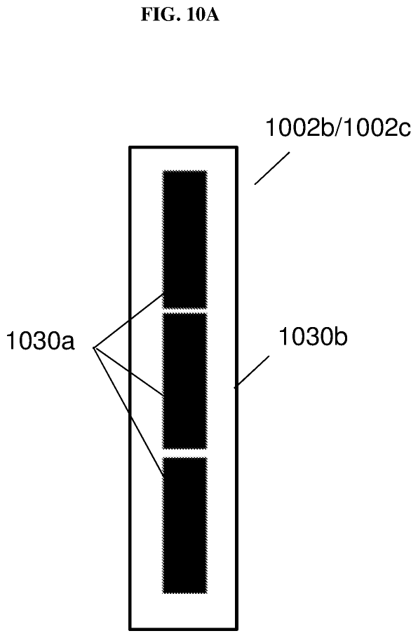

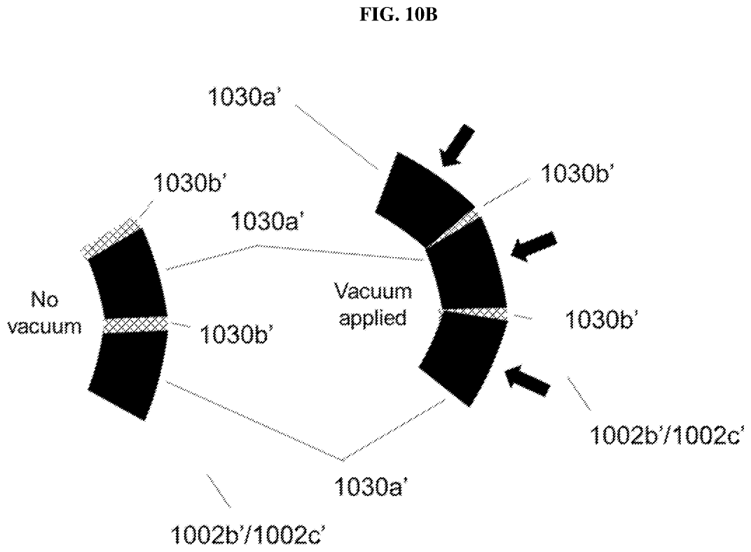

FIGS. 10A-B show various embodiments of a structural member or wall 1002b/1002c or 1002b′/1002c′ which may be similar to walls 1002b/1002c, but which may include rubber and metal inserts.

FIG. 10A is a schematic shows a cross-section of an end portion of the structural member or wall 1002b/1002c according to various embodiments. As shown in FIG. 10A, the end portion may include metal inserts 1030a (e.g. aluminum), surrounded by rubber 1030b (e.g. polydimethylsiloxane or PDMS).

FIG. 10B is a schematic shows a cross-section of an end portion of the wall 1002b′/1002c′ according to various other embodiments before vacuum is applied (left), and after vacuum is applied (right). The end portion may include neighboring metal inserts 1030a′ (e.g. aluminum) spaced by rubber 1030b′ (e.g. PDMS). The end portion may have a curved cross-section as shown in FIG. 10B. After the vacuum is applied, the neighbouring metal inserts 1030a′ may contact each other as a result of compression forces arising from a difference between pressure in the compartment and atmospheric pressure.

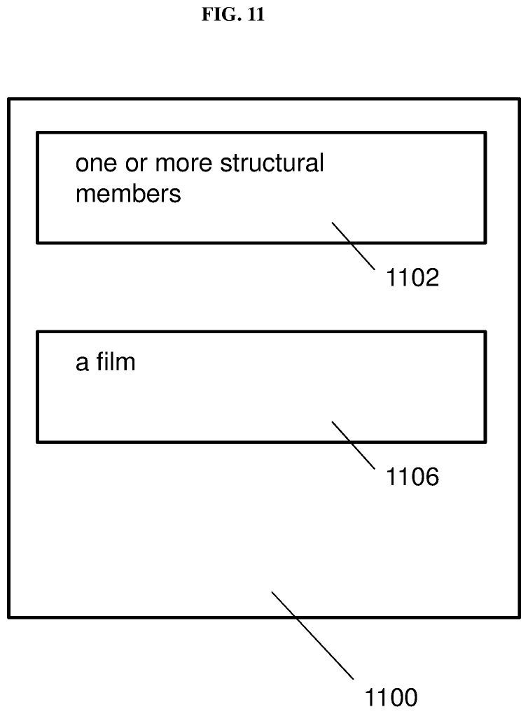

FIG. 11 is a general illustration of an apparatus 1100 for maintaining pressure according to various embodiments. The apparatus 1100 may include a plurality of structural members 1102 coupled together to at least partially define a space which is configured to have a pressure different from atmospheric pressure, a structural member of the plurality of structural members 1102 being a support structure having an array of holes. The apparatus 1100 may also include a film 1106 covering a surface of the support structure having an array of holes.

In other words, the apparatus 1100 may include a plurality of structural members 1102 coupled together to partially or fully enclose a space having a pressure higher or lower than atmospheric pressure. One of the structural members 1102 may be a support structure including a plurality of holes extending from a first surface of the support structure to a second surface of the support structure opposite the first surface. The apparatus 1100 may also include a film 1106 which covers the support structure.

The plurality of structural members 1102 may be attached or joined together, or may be formed from a single piece of material. The plurality of structural members 1102 coupled together may refer to embodiments in which the plurality of structural members 1102 are attached or joined together, as well as embodiments in which the plurality of structural members 1102 are parts of an integral piece.

A further structural member of the plurality of structural members 1102 may include a port. The apparatus 1100 may include a pressure difference generator coupled to the port and configured to generate the pressure. Various embodiments may be suitable for or configured to generate the pressure.

In various embodiments, the plurality of structural members 1102 and the film 1106 may form an enclosed chamber defining the space. The space may be fully enclosed by the structural members 1102 and the film 1106.

In various other embodiments, the plurality of structural members 1102 and the film 1106 may be configured to define the space with a surface of an object when the apparatus is arranged onto the surface of the object. For instance, the plurality of structural members may form a cover and the film may attached to the cover so that the film extends or stretches across the support structure including a plurality of holes. The cover may be arranged onto a surface of an object to define the space between the cover and the surface of the object.

In various embodiments, the apparatus 1100 may include a sealing rubber structure coupled to the plurality of structural members 1102 so that the sealing rubber structure is configured to contact the surface of the object when the apparatus 1100 is arranged onto the surface of the object.

In various embodiments, the apparatus 1100 may include a clamping mechanism, e.g. a clamp, attached to a structural member other than the support structure having the array of holes. The clamping mechanism may form an air tight seal between edges of the film 1106 and the structural member 1102 attached to the clamping mechanism. The clamping mechanism may include a rubber ring and a compression plate.

The plurality of structural members may include a plurality of walls joined together. The term “wall” in the current context may not be limited to lateral or vertical walls, and may also include for instance a ceiling. The plurality of walls may be integrally formed from a single piece of material.

In various embodiments, the apparatus 1100 may include a frame holding the plurality of walls. The frame and the plurality of walls may be formed from different materials. The apparatus 1100 may include a stiffener between each of the plurality of walls and the frame.

In various embodiments, the frame may include a port for coupling a pressure difference generator. In various other embodiments, a wall of the plurality of walls may include a port for coupling a pressure difference generator.

The plurality of structural members 1102 including the support structure with the array of holes may form a single integral structure. The support structure with the array of holes may be distinct from remaining structural members of the plurality of structural members. The array of holes may occupy (a value of) more than 50% of an area within the support structure.

Each hole of the array of holes may be of a size and a shape such that the film is within an ultimate tensile stress limit of the film upon achieving a predetermined pressure difference.

Each hole of the array of holes may have a shape such that a circle fitted into the shape touches at least three sides of the shape, while a radius (R) of the circle satisfies an equation R<σ×d×1.4/ΔP, wherein a represent an ultimate tensile strength of the film 1106, d represents a thickness of the film 1106, and ΔP is a pressure differential across the film 1106.

In various embodiments, the film 1106 may be placed or arranged on an outside or exterior surface of the support structure. The film 1106 may be placed or arranged on an outside or exterior surface of the support structure if a vacuum, i.e. a pressure lower than atmospheric pressure is required inside the chamber or space.

In various other embodiments, the film 1106 may be placed or arranged on an inside or interior surface of the support structure. The film 1106 may be placed or arranged on an inside or interior surface of the support structure if a pressure higher than atmospheric pressure is required inside the chamber or space.

The electromagnetic waves may be X-rays, ultraviolet light, visible light, infrared light, or terahertz radiation. The film 1106 may be polyethylene.

Various embodiments may relate to an apparatus suitable for or configured to repair an object. Various embodiments relating to an apparatus suitable for or configured to repair an object may include the film 1106 and the support structure including the array of holes. In various embodiments, the film 1106 may allow at least a portion of electromagnetic waves to pass through, while various other embodiments may block all electromagnetic waves. Yet various embodiments may relate to an apparatus without the film and/or the support structure.

In various embodiments, the plurality of structural members 1102 may be coupled together to at least partially define a main chamber containing the space, and also to at least partially define a secondary chamber containing a further space configured to have a further pressure different from the pressure in the main chamber. The secondary chamber may be within the main chamber.

The plurality of structural members 1102 may include one or more partition walls separating the main chamber and the secondary chamber. The plurality of structural members 1102 may include one or more external walls separating the main chamber from an external environment.

The apparatus 1100 may include a sealing film attached to the one or more partition walls for enclosing the secondary chamber. The one or more structural members 1102 may include a main chamber port and a secondary chamber port. The apparatus further may include a vacuum pump coupled via the main chamber port to the main chamber, the vacuum pump configured to generate a vacuum in the main chamber. The apparatus may include a pressure difference generator coupled via the secondary chamber port to the secondary chamber.

The sealing film 1106 may be configured to apply a compaction force on a non-polymerized composite patch, the composite patch arranged on a surface of an object, in response to a pressure difference between the main chamber and the second chamber.

The pressure difference generator may include a vacuum pump configured to generate a vacuum in the secondary chamber. The pressure difference generator may also include an air compressor configured to provide pressurized air to the secondary chamber. The pressure difference generator may further include a switch coupling the vacuum pump to the secondary chamber port when the switch is in a first state, and coupling the air compressor to the secondary chamber port when the switch is in the second state. The switch may be configured to switch between the first state, and the second state.

The compaction force provided by the sealing film 1106 on the non-polymerized composite patch may be higher than a predetermined value upon the air compressor increasing a pressure in the secondary chamber (e.g. to a value above 1 bar). The pressure may be increased in the secondary chamber by providing the pressurized air to the secondary chamber. The pressure in the main chamber may be reduced, e.g. at an absolute pressure below 0.1 bar, to keep the apparatus attached to the surface of the object. The pressure in the main chamber may be reduced by generating the vacuum in the main chamber.

The compaction force provided by the sealing film 1106 on the non-polymerized composite patch may be lower than the predetermined value upon the vacuum pump reducing a pressure in the secondary chamber (e.g. to a value below 0.1 bar). The pressure in the secondary chamber may be reduced by generating the vacuum in the secondary chamber. The pressure in the main chamber may be reduced, e.g. to a pressure below 0.05 bar. The pressure in the main chamber may be reduced by generating the vacuum in the main chamber.

The pressure difference of at least 0.05 bar may be maintained between the secondary chamber and the main chamber.

The apparatus 1100 may also include a breather layer or a foam rubber spacer coupled to the one or more partition walls, the breather layer or the foam rubber spacer configured to allow a volatile substance to be drawn from the patch into the vacuum generated in the main chamber.

The apparatus 1100 may additionally include a heat blanket layer coupled to the breather layer or the foam rubber spacer. The heat blanket may include a heat transfer fluid. The heat transfer fluid may be water or silicone oil.

Each of the one or more partition walls may have an adjustment mechanism to vary a height of the partition wall.

Each of the one or more external walls may have an end portion comprising rubber and metal inserts.

The apparatus 1100 may also include a release film coupled to the heat blanket, the release film configured to contact the patch.

The apparatus 1100 may further include a plurality of vacuum cups configured to attach to the object. The apparatus may also include a plurality of arms, each arm of the plurality of arms joining a respective vacuum cup of the plurality of vacuum cups to the one or more structural members.

The pressure in the main chamber (Pₘₐᵢₙ) and the pressure in the secondary chamber (P_{secondary}) may be related to an area covered by the main chamber (Aₘₐᵢₙ) and an area covered by the secondary chamber (A_{secondary}) by an equation

$${A}_{main} > {A}_{secondary} \times \frac{{P}_{secondary} - {P}_{atm}}{{P}_{atm} - {P}_{main}} ,$$

wherein Pₐₜₘ is the atmospheric pressure.

In the current context, the area covered by the main chamber may refer to an area of the ceiling of the main chamber. The area cover by the secondary chamber may refer to an area of the ceiling of the secondary chamber.

The main chamber may have a covering area (i.e. the main area covered by the main chamber) at least 6 times of an area of the composite patch so that the pressure in the chamber is of a value up to 6 bar during curing.

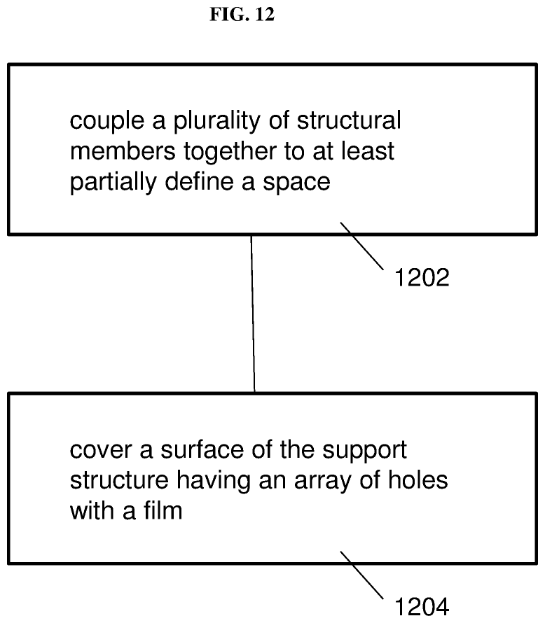

FIG. 12 is a general illustration of a method of forming an apparatus for maintaining a pressure different from atmospheric pressure according to various embodiments. The method may include, in 1202, coupling a plurality of structural members together to at least partially define a space which is configured to have a pressure different from atmospheric pressure, a structural member of the plurality of structural members being a support structure having an array of holes. The method may also include, in 1204, covering a surface of the support structure having an array of holes with a film. The film may be configured to allow a predetermined range of wavelengths of electromagnetic waves to pass through.

In various embodiments, a further structural member of the plurality of structural members may include a port. The method may include coupling a pressure difference generator to the port, the pressure difference generator configured to generate the pressure.

In various embodiments, the plurality of structural members and the film may form an enclosed chamber defining the space.

In various other embodiments, the plurality of structural members and the film may be configured to define the space with a surface of an object when the apparatus is arranged onto the surface of the object.

In various embodiments, the method may include coupling a sealing rubber structure to the plurality of structural members so that the sealing rubber structure is configured to contact the surface of the object when the apparatus is arranged onto the surface of the object. The sealing rubber structure may be made of foam material.

In various embodiments, the method may also include attaching a clamping mechanism, e.g a clamp, to a structural member other than the support structure other than the structure having the array of holes. The clamping mechanism may form an air tight seal between edges of the film and the structural member attached to the clamping mechanism.

In various embodiments, the clamping mechanism may include a rubber ring and a compression plate.

In various embodiments, the plurality of structural members may include a plurality of walls joined together.

In various embodiments, the plurality of walls may be integrally formed from a single piece of material.

In various embodiments, the method may include forming a frame holding the walls. The frame and the plurality of walls may be formed from different materials.

In various embodiments, the method may include providing a stiffener between each of the plurality of walls and the frame.

In various embodiments, the frame may include a port for coupling a pressure difference generator.

In various other embodiments, a wall of the plurality of walls may include a port for coupling a pressure difference generator.

In various embodiments, the plurality of structural members including the support structure with the array of holes may form a single integral structure.

In various other embodiments, the support structure with the array of holes may be distinct from remaining structural members of the plurality of structural members.

The array of holes may occupy more than 50% of an area within the support structure. Each hole of the array of holes may be of a size and a shape such that the film is within an ultimate tensile stress limit of the film upon achieving a predetermined pressure difference.

Each hole of the array of holes may have a shape such that a circle fitted into the shape touches at least three sides of the shape, while a radius (R) of the circle satisfies an equation R<σ×d×1.4/ΔP, wherein a represent an ultimate tensile strength of the film, d represents a thickness of the film, and ΔP is a pressure differential across the film.

In various embodiments, the film may be placed on an outside surface of the support structure. In various other embodiments, the film may be placed on an inside surface of the support structure.

The electromagnetic waves may be X-rays, ultraviolet light, visible light, infrared light, or terahertz radiation. The film may include polyethylene, nylon, silicone, or rubber.

The plurality of structural members may be coupled together to at least partially define a main chamber containing the space, and also to at least partially define a secondary chamber containing a further space configured to have a further pressure different from the pressure in the main chamber. The secondary chamber may be within the main chamber.

The plurality of structural members may include one or more partition walls separating the main chamber and the secondary chamber. The plurality of structural members may include one or more external walls separating the main chamber from an external environment.

The method may also include attaching a sealing film to the one or more partition walls for enclosing the secondary chamber.

The one or more structural members may include a main chamber port and a secondary chamber port. The apparatus further may include a vacuum pump coupled via the main chamber port to the main chamber, the vacuum pump configured to generate a vacuum in the main chamber. The apparatus may include a pressure difference generator coupled via the secondary chamber port to the secondary chamber.

The sealing film may be configured to apply a compaction force on a non-polymerized composite patch, the composite patch arranged on a surface of an object, in response to a pressure difference between the main chamber and the second chamber.

The pressure difference generator may include a vacuum pump configured to generate a vacuum in the secondary chamber. The pressure difference generator may also include an air compressor configured to provide pressurized air to the secondary chamber. The pressure difference generator may further include a switch coupling the vacuum pump to the secondary chamber port when the switch is in a first state, and coupling the air compressor to the secondary chamber port when the switch is in the second state. The switch may be configured to switch between the first state, and the second state.

The compaction force provided by the sealing film on the non-polymerized composite patch may be higher than a predetermined value upon the air compressor increasing a pressure in the secondary chamber (e.g. to a value above 1 bar). The pressure may be increased in the secondary chamber by providing the pressurized air to the secondary chamber. The pressure in the main chamber may be reduced, e.g. at an absolute pressure below 0.1 bar, to keep the apparatus attached to the surface of the object. The pressure in the main chamber may be reduced by generating the vacuum in the main chamber.

The compaction force provided by the sealing film on the non-polymerized composite patch may be lower than the predetermined value upon the vacuum pump reducing a pressure in the secondary chamber (e.g. to a value below 0.1 bar). The pressure in the secondary chamber may be reduced by generating the vacuum in the secondary chamber. The pressure in the main chamber may be reduced, e.g. to a pressure below 0.05 bar. The pressure in the main chamber may be reduced by generating the vacuum in the main chamber.

In various embodiments, the method may include coupling a breather layer or a foam rubber spacer to the one or more partition walls, the breather layer or the foam rubber spacer configured to allow a volatile substance to be drawn from the patch into the vacuum generated in the main chamber.

In various embodiments, the method may include coupling a heat blanket layer to the breather layer or the foam rubber spacer. The heat blanket may include a heat transfer fluid, such as water or silicone oil.

In various embodiments, each of the one or more partition walls may have an adjustment mechanism to vary a height of the partition wall. Each of the one or more external walls may have an end portion comprising rubber and metal inserts.

The method may include coupling a release film to the heat blanket, the release film configured to contact the patch.

In various embodiments, the method may include joining each of a plurality of vacuum cups configured to attach to the object to the one or more structural members via a respective arm.

The pressure in the main chamber (Pₘₐᵢₙ) and the pressure in the secondary chamber (P_{secondary}) may be related to an area covered by the main chamber (Aₘₐᵢₙ) and an area covered by the secondary chamber (A_{secondary}) by an equation

$${A}_{main} > {A}_{secondary} \times \frac{{P}_{secondary} - {P}_{atm}}{{P}_{atm} - {P}_{main}} ,$$

wherein Pₐₜₘ is the atmospheric pressure.

The main chamber may have a covering area at least 6 times of an area of the composite patch so that the pressure in the chamber is of a value up to 6 bar during curing.

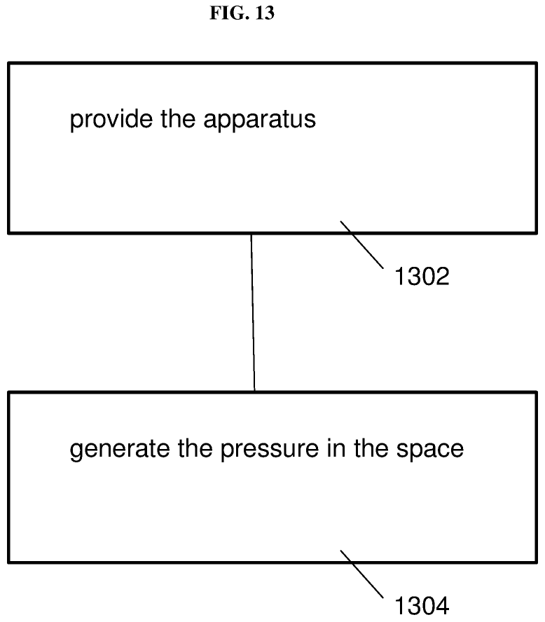

FIG. 13 is a general illustration of a method of operating an apparatus for maintaining a pressure different from atmospheric pressure according to various embodiments. The method may include, in 1302, providing the apparatus. The apparatus may include a plurality of structural members coupled together to at least partially define a space which is configured to have a pressure different from atmospheric pressure, a structural member of the plurality of structural members being a support structure having an array of holes. The apparatus may also include a film covering a surface of the support structure having an array of holes. The film may be configured to allow a predetermined range of wavelengths of electromagnetic waves to pass through. The method may also include, in 1304, generating the pressure in the space.

The method may include coupling a pressure difference generator to a port of the apparatus to generate the pressure. The plurality of structural members may form a cover.

In various embodiments, the method may include arranging the cover on the surface of an object containing defects. The pressure difference generator may include a vacuum pump coupled to the cover, the vacuum pump configured to generate a vacuum in the space enclosed by the cover and the surface so that the pressure is lower than atmospheric pressure. The method may include providing infrared light through the film onto the surface of the object. The vacuum may be generated to carry out vacuum assisted thermography to detect the defects.

In various emboidments, the pressure difference generator may include a vacuum pump coupled to the cover, the vacuum pump configured to generate a vacuum in the space enclosed by the cover and the surface so that the pressure is lower than atmospheric pressure. The method may include arranging a patch on a surface of the object; arranging a vacuum bag over the patch after arranging the patch; arranging the cover on the surface so that the patch is within the space enclosed by the cover and the surface before generating a vacuum so that the pressure is lower than atmospheric pressure to perform double vacuum debulking (DVD) on the patch.

In various embodiments, the apparatus further may include a sealing film. The plurality of structural members and the sealing film may define the space.

The pressure difference generator may include an air compressor coupled to the space, the air compressor configured to provide pressurized air to the space enclosed by the cover and the surface so that the pressure is higher than atmospheric pressure.

The method may include arranging the apparatus over a patch on a surface of an object before generating the pressure; and generating the pressure so that the sealing film compresses against the patch whilst curing the patch.

In varioues embodiments, the plurality of structural members may be coupled together to at least partially define a main chamber containing the space, and also to at least partially define a secondary chamber containing a further space configured to have a further pressure different from the pressure in the main chamber.

In various embodiments, the pressure difference generator may be coupled to the secondary chamber. The apparatus may further include a vacuum pump coupled to the main chamber configured to generate a vacuum in the main chamber.

The pressure difference generator may include a vacuum pump configured to generate a vacuum in the secondary chamber. The pressure difference generator may also include an air compressor configured to provide pressurized air to the secondary chamber. The pressure difference generator may also include a switch coupling the vacuum pump and the air compressor to the secondary chamber port.

The switch may be configured to switch between a first state coupling the vacuum pump of the pressure difference generator to the secondary chamber, and a second state coupling the air compressor to the secondary chamber.

The method may also include arranging the apparatus over a patch on a surface of an object. The method may also include activating the switch to be in the first state so that vacuum pump generates the vacuum in the secondary chamber. The method may further include activating the vacuum pump coupled to the main chamber to generate the vacuum in the main chamber to reduce the compaction force on the repair patch via the sealing film and to draw volatiles from the patch, thereby carrying out debulking of the patch.

The method may further include activating the switch to be in the second state so that the air compressor provides the pressurized air to the secondary chamber and the sealing film compresses the patch, before, during and after heat input.

The method may also include setting a desired temperature to a control unit for debulking and/or curing, so that a heat blanket layer in electrical connection with the control unit may be configured to heat the patch to the desired temperature. One or more thermocouples electrically connected to the control unit may detect a temperature of the patch or object, and transmit the detected temperature to the control unit. The control unit may control the heat blanket layer based on the predetermined desired temperature and the detected temperature.

Various embodiments may relate to a lightweight, single-unit and scalable design for a device to perform composite repair. The device can be used at different angles (such as upside down) which is beneficial for applications such as aircraft repair. A differentiating factor from current state-of-the-art may be the lightweight design, which improves handling and productivity of this device.

Various embodiments may relate a portable apparatus for in-situ composite repair including a cover having a ceiling and sidewalls to define a volume of space to be enclosed by the cover when the cover is placed on a surface, a ceiling including a perforated portion, and a layer of transparent film sealed to the ceiling and stretched across the perforated portion.

The transparent film may include a film transparent in the visible and infrared range such as polyethylene, nylon, silicone, or rubber.

The cover may further include support ribs extending between the ceiling and the sidewalls. The cover may include partition walls configured to divide the volume of space into a first space and a second space. The partition walls define the perimeter of the second space and a flexible vacuum sealing film is hermetically sealed across the partition walls at a base to isolate the second space from the first space. The partition walls may have variable height adjustment.

An air compressor and a vacuum pump may be connected to the second space. The pressure in the second space can be changed from positive to negative by way of a switch between the compressor and vacuum pump. The pressure in the second space may be switched without removal of the device from the surface. A negative pressure in the second space may allow the device to be used for double vacuum debulking. A positive pressure in the second space may allow lower porosity, reduced fibre wrinkling and higher conformity after thermal curing of the non-polymerized composite.

A breather, a thermocouple, a heat blanket and a non-porous release film may be attached to the base of the second space. The non-porous release film may be in direct contact with the non-polymerized composite patch or structure such that it can apply pressure by directional expansion. The second space may be pressurized up to 6 bar while maintaining a ratio of the area of the ceiling of the cover to the area of the flexible vacuum sealing film is 6:1.

The sidewalls may have foam rubber attached to the base. The sidewalls of the cover may be flexible. The sidewalls of the cover may include rubber and metal inserts.

The apparatus may further include a plurality of vacuum cups connected to the cover. The sidewalls of the cover may include pass-through connectors for the thermocouple and heat blanket cables. The heat blanket may include a heat transfer fluid. The cover may be self-aligning to underlying structural contour (flat, curved, double-curved).

An initial prototype of the apparatus to enhance the DVD process was successfully demonstrated in-house on composite repair with repaired laminates passing all repair requirements, while also demonstrating significant time/manpower savings due to lightweight/portable design enhancements.

Various embodiments may be of benefit to the aircraft MRO sector. New applications in the areas of oil and gas (O&G), transport and energy are expected to emerge with the increased use of composite materials.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An apparatus for maintaining a pressure different from atmospheric pressure, the apparatus comprising:
a plurality of structural members coupled together to at least partially define a space which is configured to have a pressure different from an external pressure, a structural member of the plurality of structural members being a support structure having an array of holes; and
a stretchable membrane covering a surface of the support structure having the array of holes;
wherein the membrane is adapted to allow a predetermined range of wavelengths of electromagnetic waves to pass through.

2. The apparatus according to claim 1,
wherein a further structural member of the plurality of structural members comprises a port; and
wherein the apparatus comprises a pressure difference generator coupled to the port and configured to generate a pressure difference between the pressure in the defined space and the external pressure.

3. The apparatus according to claim 1,
wherein the plurality of structural members and the membrane form an enclosed chamber defining the space; and
wherein the membrane comprises polyethylene, nylon, silicone, or rubber.

4. The apparatus according to claim 1,
wherein the plurality of structural members and the membrane are configured to define the space with a surface of an object when the apparatus is arranged onto the surface of the object; and
wherein the apparatus further comprises a sealing rubber structure coupled to the plurality of structural members so that the sealing rubber structure is configured to contact the surface of the object when the apparatus is arranged onto the surface of the object.

5. (canceled)

6. The apparatus according to claim 1, further comprising:
a clamping mechanism attached to a structural member other than the support structure having the array of holes;
wherein the clamping mechanism forms an air tight seal between edges of the membrane and the structural member attached to the clamping mechanism.

7-15. (canceled)

16. The apparatus according to claim 1, wherein the array of holes occupies more than 50% of an area within the support structure.

17. The apparatus according to claim 1, wherein each hole of the array of holes is of a size and a shape such that the film is within an ultimate tensile stress limit of the film upon achieving a predetermined pressure difference.

18-22. (canceled)

23. The apparatus according to claim 1, wherein the plurality of structural members is coupled together to at least partially define a main chamber containing the space, and also to at least partially define a secondary chamber within the main chamber, the secondary chamber containing a further space configured to have a further pressure different from the pressure in the main chamber.

24-25. (canceled)

26. The apparatus according to claim 23, further comprising:
a sealing membrane attached to one or more partition walls of the plurality of structural members separating the main chamber and the secondary chamber, thus enclosing the secondary chamber.

27. The apparatus according to claim 26,
wherein the one or more structural members comprise a main chamber port and a secondary chamber port;
wherein the apparatus further comprises:
a vacuum pump coupled via the main chamber port to the main chamber, the vacuum pump configured to generate a vacuum in the main chamber; and
a pressure difference generator coupled via the secondary chamber port to the secondary chamber.

28. The apparatus according to claim 27, wherein the sealing membrane is configured to apply a compaction force on a surface of an object or a sample placed between the sealing membrane and the surface of the object in response to a pressure difference between the main chamber and the secondary chamber.

29. (canceled)

30. The apparatus according to claim 28,
wherein the compaction force provided by the sealing membrane on the sample sandwiched between the sealing membrane and the surface of the object is higher than a predetermined value upon the air compressor increasing a pressure in the secondary chamber to a value above 1 bar; and
wherein the pressure in the main chamber is at an absolute pressure below 0.1 bar to keep the apparatus attached to the surface of the object.

31-33. (canceled)

34. The apparatus according to claim 28, further comprising:
a heat blanket layer placed between the sealing membrane and the surface of the object.

35-36. (canceled)

37. The apparatus according to claim 26, wherein each of the one or more partition walls has an adjustment mechanism to vary a height of the partition wall.

38-40. (canceled)

41. The apparatus according to claim 28, wherein a gauge pressure in the main chamber (Pₐₜₘ−Pₘₐᵢₙ) and a gauge pressure in the secondary chamber (P_{secondary}−Pₐₜₘ) are related to an area covered by the main chamber (Aₘₐᵢₙ) and an area covered by the secondary chamber (A_{secondary}) by an equation
$${A}_{main} > {A}_{secondary} \times \frac{{P}_{secondary} - {P}_{atm}}{{P}_{atm} - {P}_{main}} ,$$
and wherein Pₐₜₘ is the atmospheric pressure.

42. (canceled)

43. A method of forming an apparatus for maintaining a pressure different from atmospheric pressure, the method comprising:
coupling a plurality of structural members together to at least partially define a space which is configured to have a pressure different from an external pressure, a structural member of the plurality of structural members being a support structure having an array of holes; and
covering a surface of the support structure having the array of holes with a stretchable membrane;
wherein the membrane is adapted to allow a predetermined range of wavelengths of electromagnetic waves to pass through.

44-84. (canceled)

85. A method of operating an apparatus for maintaining a pressure different from atmospheric pressure, the method comprising:
providing the apparatus comprising:
a plurality of structural members coupled together to at least partially define a space which is configured to have a pressure different from an external pressure, a structural member of the plurality of structural members being a support structure having an array of holes; and
a stretchable membrane covering a surface of the support structure having the array of holes;
wherein the membrane is adapted to allow a predetermined range of wavelengths of electromagnetic waves to pass through; and
generating the pressure in the space.

86-97. (canceled)
